(19) United States
(12) Patent Application Publication
(10) Pub. No.: US 2017/0205103 A1
(43) Pub. Date: Jul. 20, 2017

(54) THERMAL HYDRAULIC HEAT PUMP FOR HVAC

(71) Applicant: Eric William Newcomb, Harrison, ME (US)

(72) Inventor: Eric William Newcomb, Harrison, ME (US)

(21) Appl. No.: 15/416,871

(22) Filed: Jan. 26, 2017

Related U.S. Application Data
(63) Continuation-in-part of application No. 13/956,897, filed on Aug. 1, 2013.
Application No. 13/956,897 is a continuation-in-part of application No. 13/134,343, filed on Sep. 7, 2011, now abandoned.
Application No. 13/134,343 is a continuation-in-part of application No. 13/507,331, filed on Jun. 21, 2012, now abandoned.
Application No. 13/507,331 is a continuation-in-part of application No. 13/573,882, filed on Oct. 12, 2012, now abandoned.
Application No. 13/573,882 is a continuation-in-part of application No. 14/444,636, filed on Jul. 28, 2014.
Application No. 14/444,636 is a continuation of application No. 14/847,724, filed on Sep. 8, 2015.
(60) Provisional application No. 62/287,239, filed on Jan. 26, 2016.

(51) Int. Cl. F24F 11/00; H02J 3/40; H02J 3/46; F02G 5/04; H02K 7/18; G05D 7/06; G05B 19/048; H02J 3/38; H02K 7/14

(52) U.S. Cl. CPC F24F 11/008; H02J 3/385; H02J 3/40; H02J 3/46; H02K 7/14; H02K 7/1853; F24F 11/006; G05D 7/0635; F24F 11/0086; G05B 19/048; F02G 5/04; F24F 2011/0061; F24F 2011/0083; F24F 2011/0091; G05B 2219/2614

(57) ABSTRACT

System, method and apparatus enabling efficient heating, cooling and demand management thereof using a thermal hydraulic heat pump.

### CROSS REFERENCE TO RELATED APPLICATIONS

This application is a continuation-in-part of application Ser. No. 13/956,897, filed on Aug. 1, 2013, a continuation-in-part of application Ser. No. 13/134,343, filed on Sep. 7, 2011, now abandoned, a continuation-in-part of application Ser. No. 13/507,331, filed on Jan. 21, 2012, now abandoned, and a continuation-in-part of application Ser. No. 13/573,882, filed on Oct. 12, 2012, now abandoned, a continuation-in-part of application Ser. No. 14/444,636, filed on Jul. 28, 2014, a continuation of Ser. No. 14/847,724 filed Sep. 8, 2015, and claims the benefit of provisional patent application Ser. No. 62/287,239, filed Jan. 26, 2016, all of these applications being incorporated herein by reference in their entireties.

### FIELD OF THE INVENTION

The invention relates to the field of Heating Ventilation and Air Conditioning and, more particularly but not exclusively, HVAC systems using a Thermal Hydraulic Heat Pump.

### BACKGROUND

Thermal Hydraulic Heat Pumps capture energy from Turbine Generators, Combustion Engines, Geothermal Sources, Facility Systems, or Solar Collectors.

### SUMMARY

Various deficiencies in the prior art are addressed by systems, methods and apparatus enabling efficient heating, cooling and demand management thereof using a thermal hydraulic heat pump.

Various embodiments comprise a thermal hydraulic heat pump, for operating heating, ventilation, and/or air conditioning systems in response to a control signal; and a controller, for adapting the control signal in response to an HVAC system load demand associated with the heating and cooling loads for a facility, the control signal being adapted to cause the thermal hydraulic heat pump to adapt its output such that the output satisfies the heating and cooling load demands for a facility. Stable thermal hydraulic heat pump cylinders and heat exchangers are disclosed.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system according to an embodiment;

FIG. 2 graphically depicts physical dimensions of an exemplary Programmable Logic Controller (PLC) suitable for use as a controller within the system of FIG. 1;

FIG. 3 graphically depicts exemplary power and signal input terminals associated with the PLC of FIG. 2;

FIGS. 4A and 4B graphically depict exemplary signal output terminals associated with the PLC of FIG. 2;

FIGS. 5A and 5B graphically depict an exemplary wiring configuration for connecting sensors/transmitters to signal input terminals associated with the PLC of FIG. 2.

FIG. 6 graphically depicts an exemplary wiring configuration for connecting an output device to signal output terminals associated with the PLC of FIG. 2;

FIGS. 7A and 7B graphically depict an exemplary wiring configuration for connecting a Resistance Temperature Detector (RTD) to excitation and sense input terminals of the PLC of FIG. 2;

FIGS. 8A and 8B graphically depict physical dimensions of an exemplary user interface device associated with the PLC of FIG. 2;

FIGS. 9A, 9B, 9C and 9D graphically depict physical dimensions for various VFDs suitable for providing circulation pump control functionality in the system of FIG. 1 in cooperation with the PLC of FIG. 2;

FIG. 10 depicts a schematic diagram of an exemplary inverter suitable for use as a grid tie inverter within the system of FIG. 1;

FIG. 11 graphically depicts a generator suitable for use within the system of FIG. 1;

FIG. 12 graphically depicts PWM synthesis of a sinusoidal waveform;

FIG. 13 depicts a high level block diagram of a system according to an embodiment.

FIG. 14 is a block diagram of a system comprising a full cycle thermal hydraulic generator system according to an embodiment;

FIG. 15 is a block diagram of a full cycle and stable thermal hydraulic generator according to an embodiment;

FIG. 16 is a block diagram of a heat exchanger according to an embodiment;

FIG. 17 depicts a high level block diagram of a system according to an embodiment;

FIG. 18 is a block diagram of a system comprising a full cycle thermal hydraulic heat pump system according to an embodiment; and

FIG. 19 depicts a schematic diagram of thermal hydraulic heat pump piping and instrumentation according to an embodiment.

To facilitate understanding, identical reference numerals have been used, where possible, to designate identical elements that are common to the figures.

### DETAILED DESCRIPTION

Thermal Hydraulic DC Generators capture energy from Turbine Generators, Combustion Engines, Geothermal Sources, Facility Systems, or Solar Collectors. These sources can be used to produce 180-degree Fahrenheit hot water in order to drive Thermal Hydraulic DC Generators. These Generators create a very efficient means of generating electric power.

Other co-generation systems require the use of steam to drive Steam Turbines. The use of steam as opposed to hot water requires more expensive equipment and more maintenance to operate than a 180 Degree F. hot water system. These 180 Degree F. hot water systems incorporating the Thermal Hydraulic DC Generators are more efficient than the Rankine Cycle or the Carnot Cycle.

Thermal Hydraulic DC Generator Engines incorporate a PLC based control system that eliminates the need for governors and voltage regulators. They incorporate inverter systems to create “clean” power at unity power factor. This is a new system that has never been accomplished before.

The technological innovation regarding the Thermal Hydraulic DC Generator revolves around regulating the flow of the hydraulic fluid to the hydraulic pump and creating the correct RPM for the DC Generator. The load demands of the building electrical system are matched through the PLC based control system and instrumentation. The generator governor and regulator have been replaced by the PLC based control system. The correct flow of hydraulic fluid is supplied to the hydraulic pump. The DC output from the generator is connected to an inverter that corrects the AC output to a unity power factor. This is a new system that has never been accomplished before.

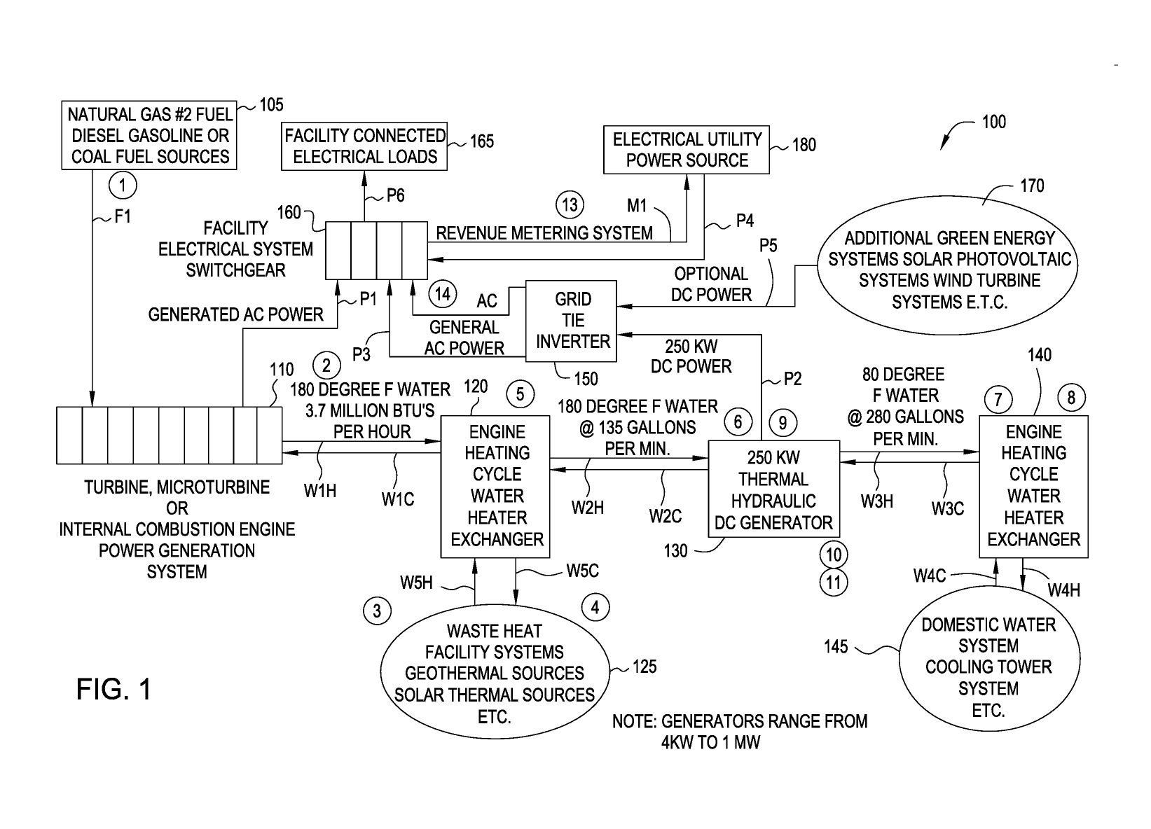

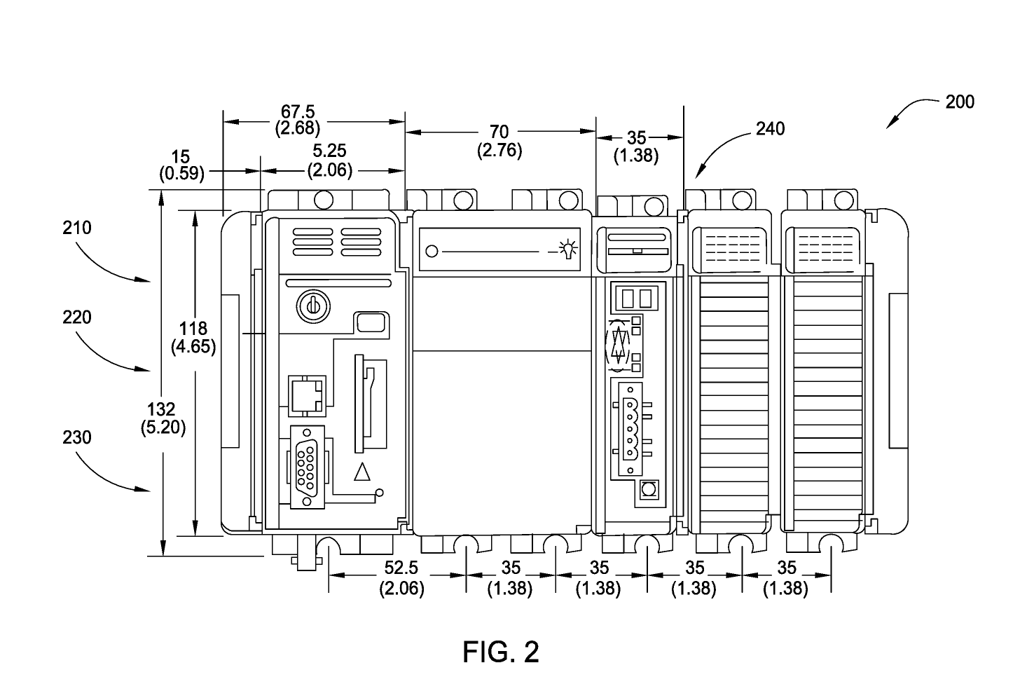

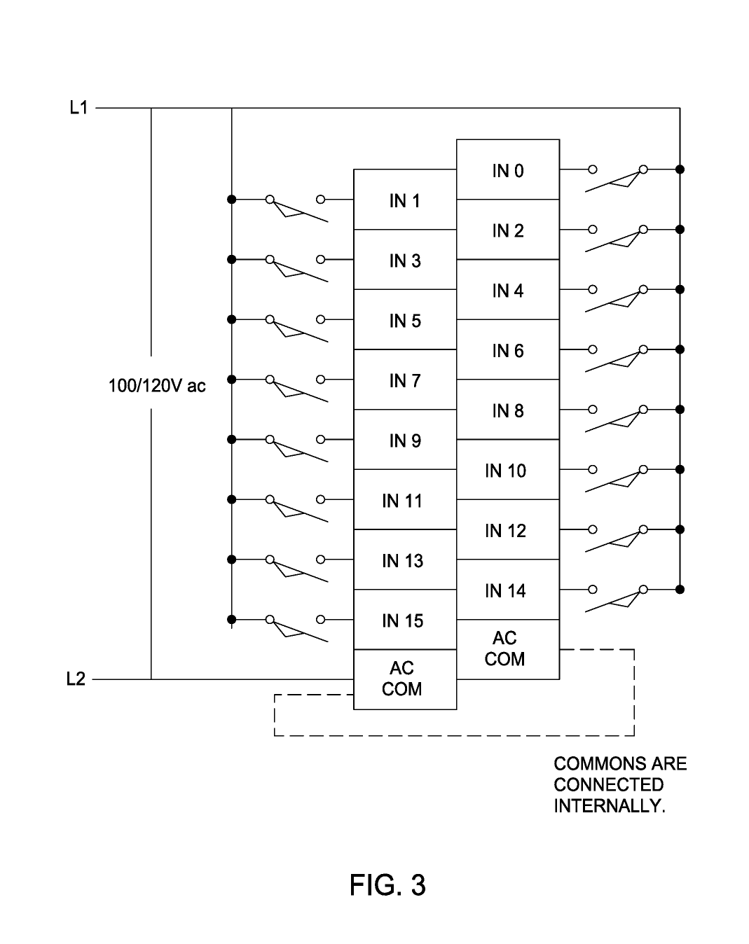

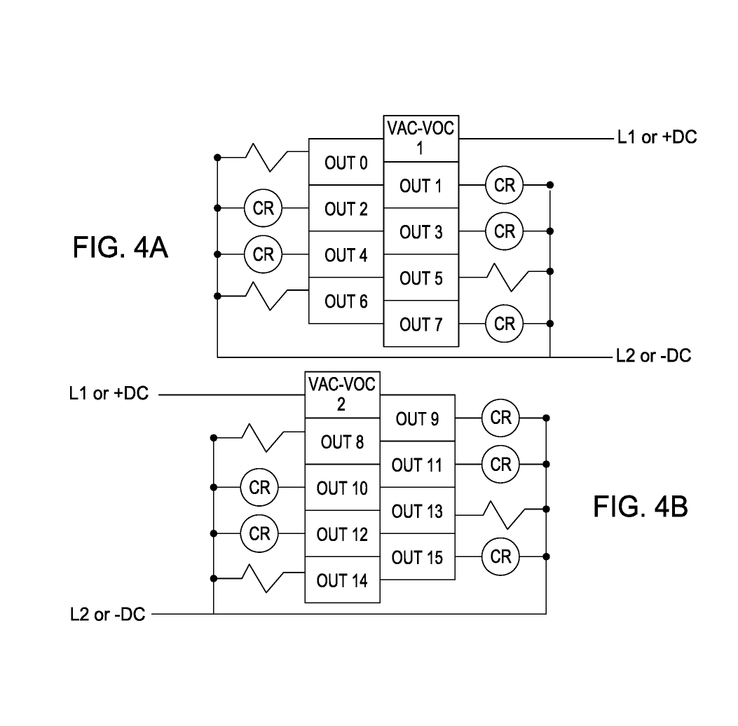

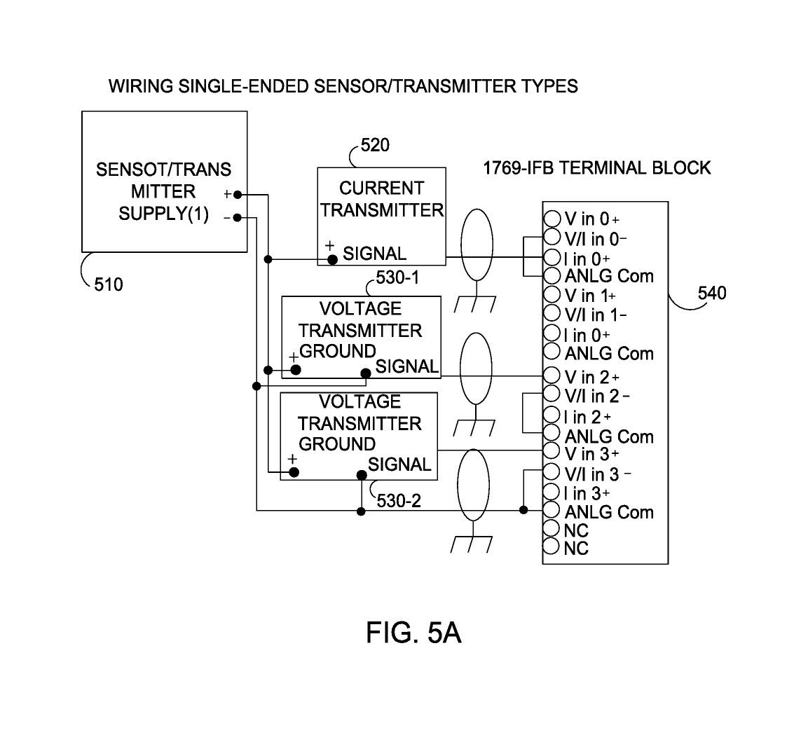

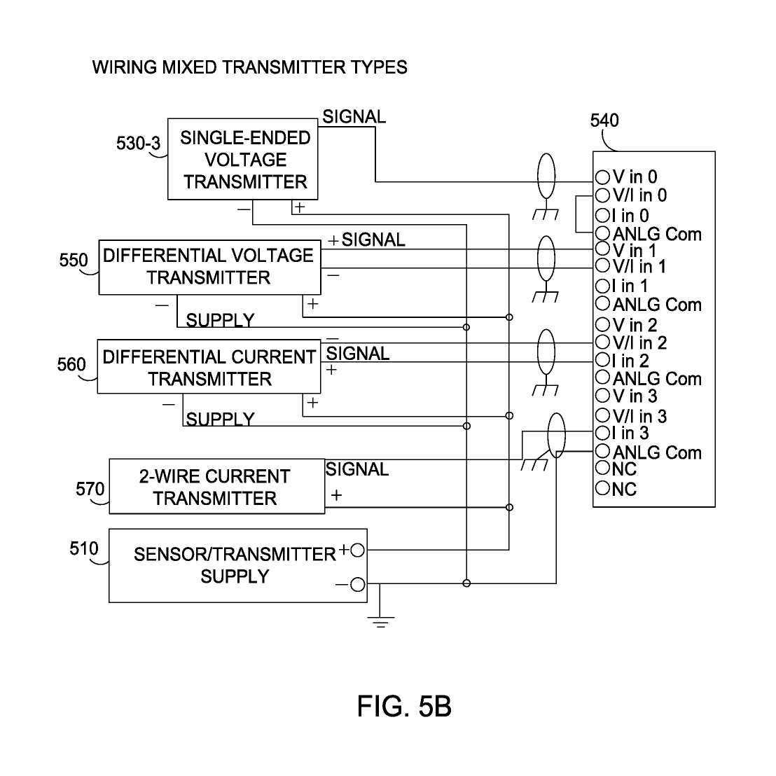

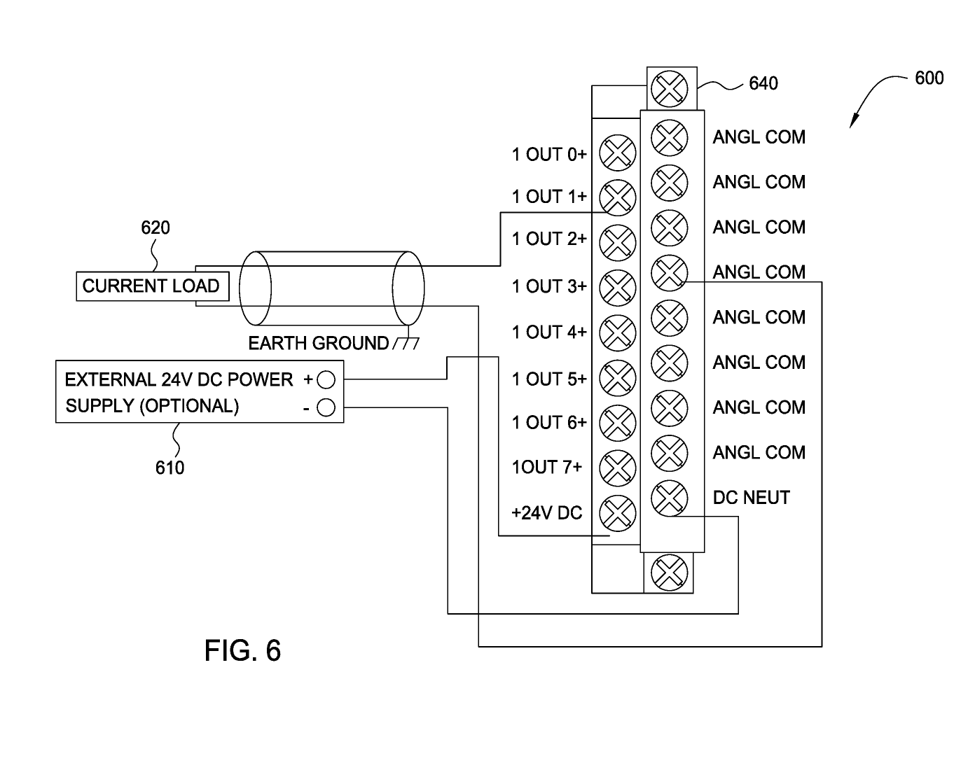

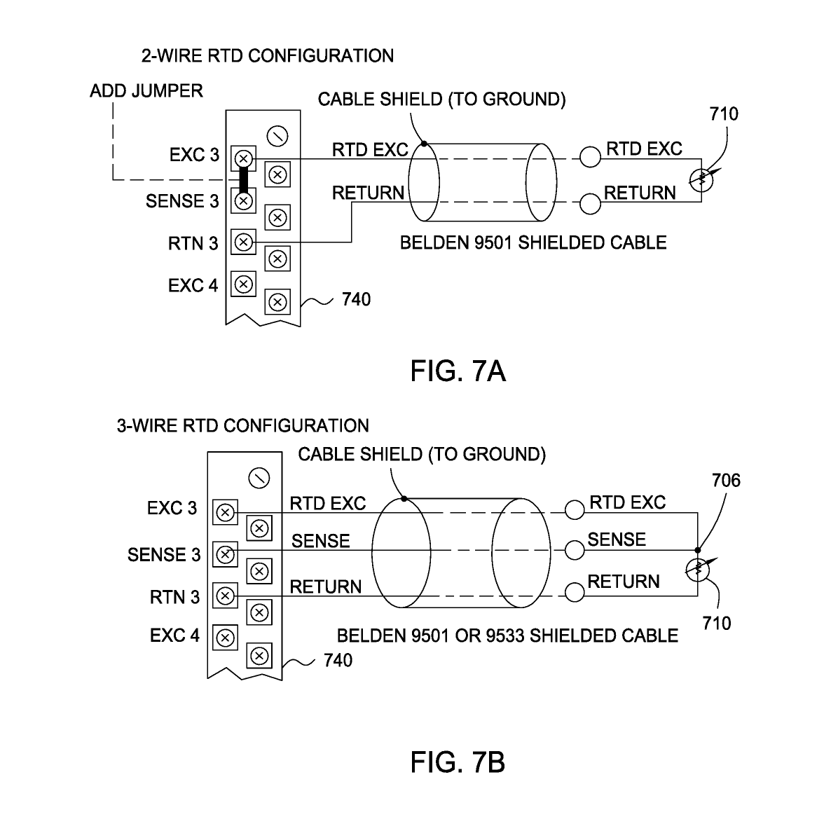

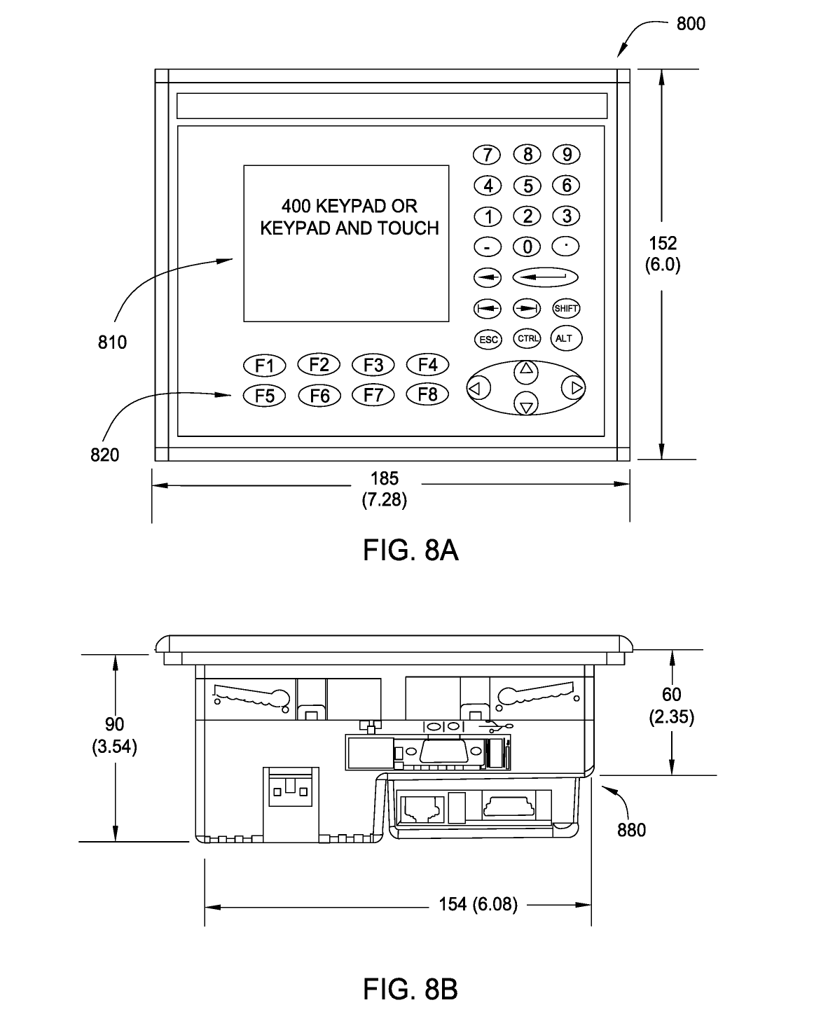

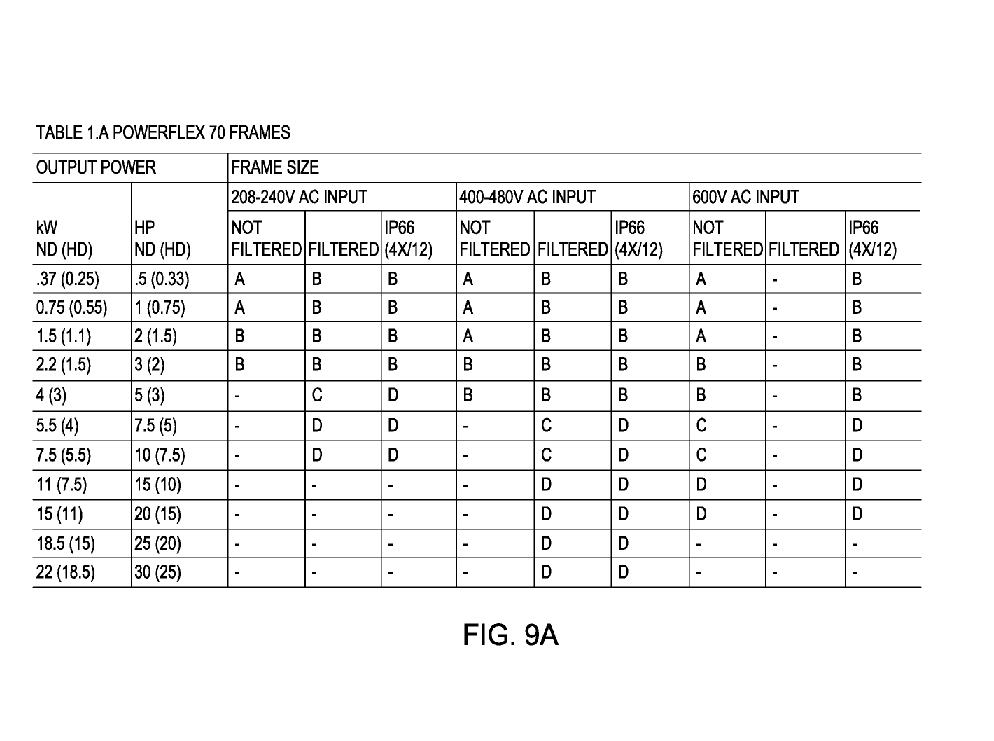

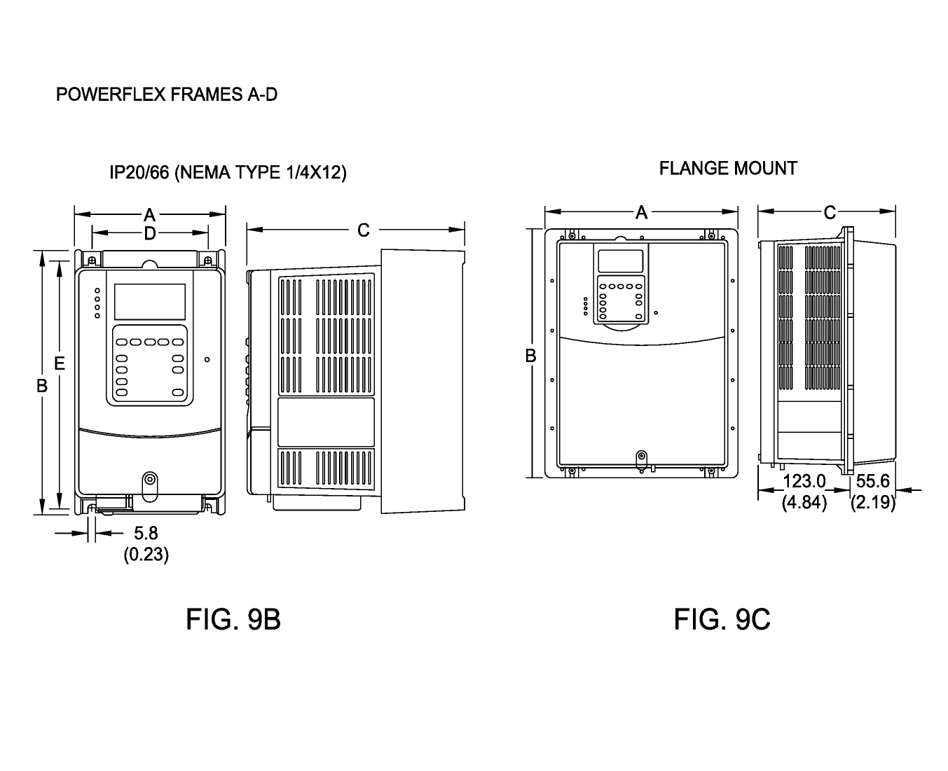

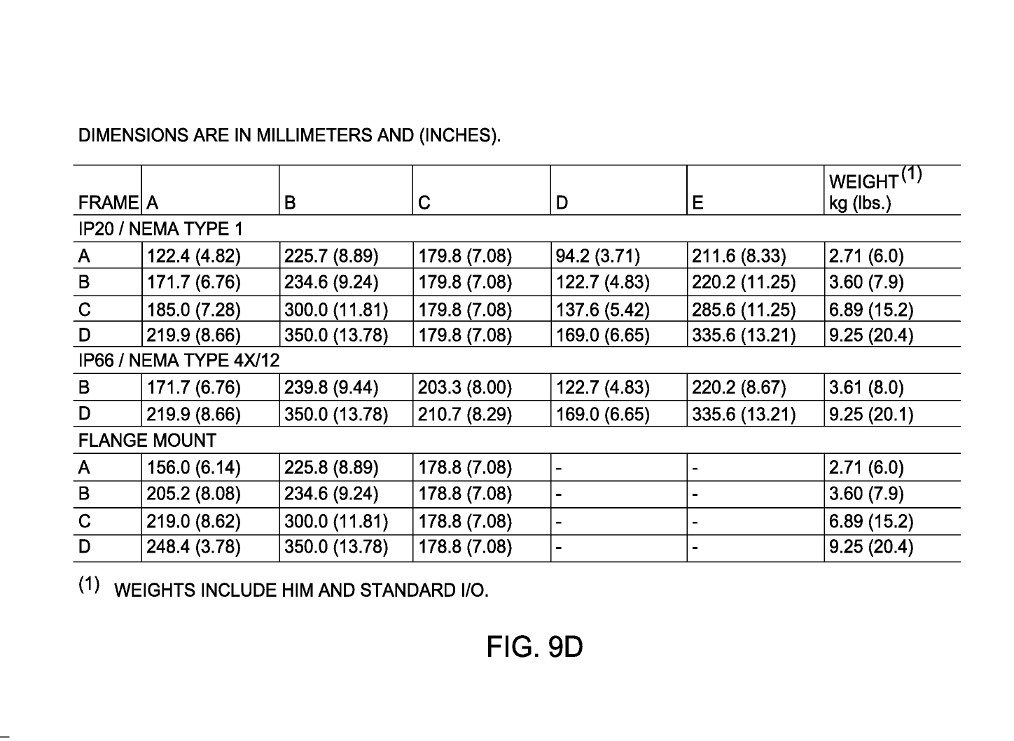

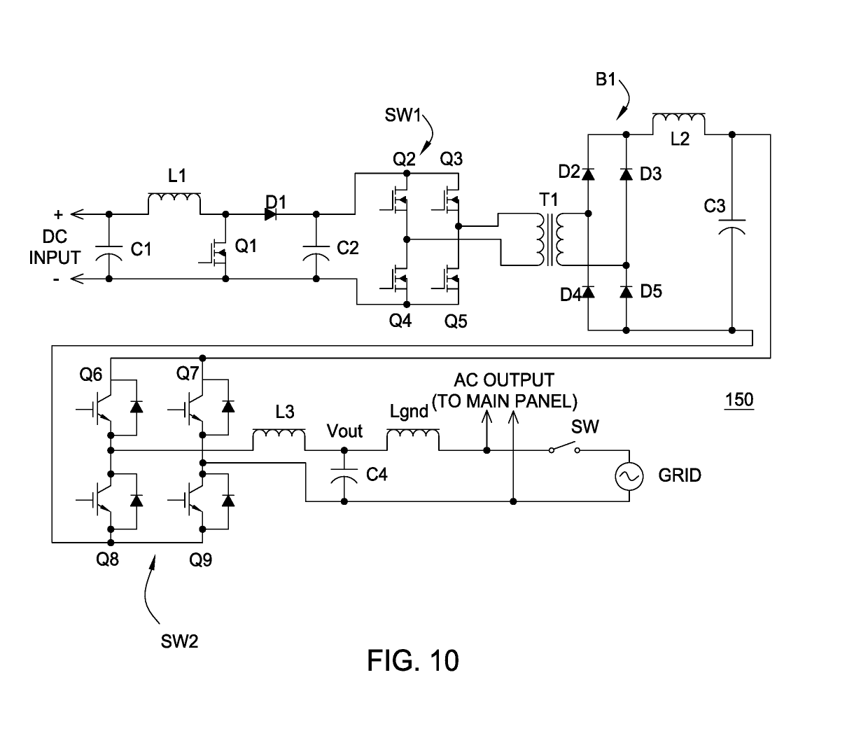

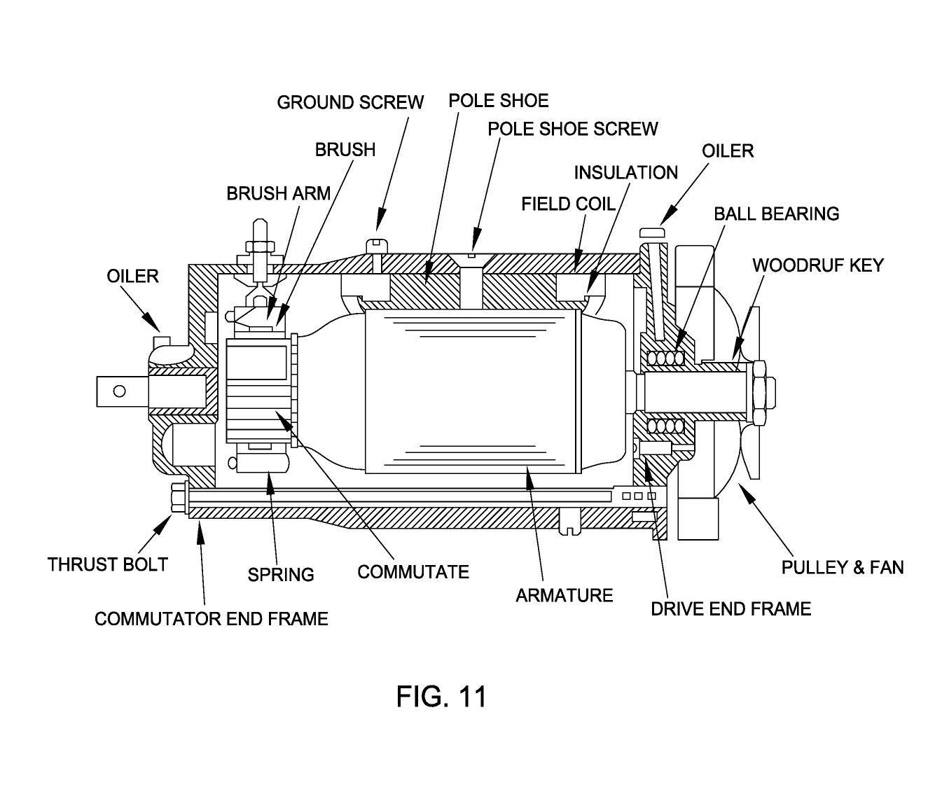

Various embodiments are described within the context of the figures. FIG. 1 represents a flow diagram for a Thermal Hydraulic DC Generator connected to a microturbine system to capture waste heat from the exhaust and increase the efficiency of the overall system. FIG. 2 represents a 32 bit microprocessor with Ethernet communications for the PLC based control system. FIG. 3 represents a discrete input module used for the PLC based control system. FIG. 4 represents a discrete output module for the PLC based control system. FIG. 5 represents an analog input module for the PLC based control system. FIG. 6 represents an analog output module for the PLC based control system. FIG. 7 represents an RTD input module for the PLC based control system. FIG. 8 represents an operator interface terminal used for the PLC based control system. FIG. 9 represents a VFD used for circulation pump control with the PLC based control system. FIG. 10 represents a grid tie inverter that will be used to convert DC power to AC Power and synchronize with the utility power grid at unity power factor. A process description is also included. FIG. 11 represents a DC generator used to generate DC power.

FIG. 1 depicts a high level block diagram of a system according to an embodiment. Generally speaking, FIG. 1 depicts a flow diagram for a Thermal Hydraulic DC Generator connected to a microturbine system to capture waste heat from the exhaust and increase the efficiency of the overall system.

Referring to FIG. 1, a system 100 includes a fuel source 105 (e.g., natural gas, #2 fuel, diesel, gasoline, coal or other fuel source), a power generation system 110 (illustratively a turbine, micro-turbine, internal combustion engine or other power generation system), an engine heating cycle water heat exchanger 120, optional heat sources 125 (illustratively waste heat from facility systems, heat from geothermal sources, heat from solar thermal sources etc.), a thermal hydraulic DC generator 130 (illustratively a 250 kW generator, or other generator ranging from 4 kW to 1 MW), an engine cooling cycle water heat exchanger 140, cooling sources 145 (illustratively a domestic water system, a cooling tower system etc.), a grid tie inverter 150, facility electrical system switchgear 160, facility connected electrical loads 165, optional additional green energy systems 170 (illustratively solar photovoltaic systems, wind turbine systems etc.) and an electrical utility power source 180.

The power generation system 110 receives fuel from the fuel source 105 via path F1, and generates AC power which is coupled to facility electrical system switchgear 160 via path P1.

The engine heating cycle water heat exchanger 120 receives 180° F. water from the power generation system 110 via path W1H (illustratively at 3.7 million BTUs per hour), and returns cooler water to the power generation system 110 via path W1C.

The engine heating cycle water heat exchanger 120 may receive hot water from optional heat sources 125 via path W5H, and return cooler water to the optional heat sources 125 via path W5C.

The engine heating cycle water heat exchanger 120 provides hot water to the thermal hydraulic DC generator 130 via path W2H, and receives cooler water from the thermal hydraulic DC generator 130 via path W2C. In the illustrated embodiment, path W2H supplies 180° F. water at a rate of 135 gallons per minute to a 250 kW thermal hydraulic DC generator 130.

The thermal hydraulic DC generator 130 provides hot water to the engine cooling cycle water heat exchanger 140 via path W3H, and receives cooler water from the engine cooling cycle water heat exchanger 140 via path W3C. In the illustrated embodiment, path W3C supplies 80° F. water at a rate of 280 gallons per minute to a 250 kW thermal hydraulic DC generator 130.

The engine cooling cycle water heat exchanger 140 provides hot water to cooling sources 145 via path W4H, and receives cooler water from the cooling sources 145 via path W4C.

The thermal hydraulic DC generator 130 generates DC power in response to the temperature differential between the 180° F. water provided via the W2H/W2C fluid loop and the 80° F. water provided via the W3H/W3C fluid loop. The DC power, illustratively 250 kW AC power, is provided to grid tie inverter 150 via path P2.

Grid tie inverter 150 may also receive additional DC power via path P5 from optional additional green energy systems 170.

Grid tie inverter 150 operates to invert received DC power to thereby generate AC power which is coupled to facility electrical system switchgear 160. Grid tie inverter 150 “ties” DC power to the electrical grid by inverting the DC power such that the resulting generated AC power conforms to power grid specifications.

Facility electrical system switchgear 160 receives AC power from electrical utility power source 180 via path P4, and provides revenue metering system information to electrical utility power source 180 via Ml.

Facility electrical system switchgear 160 operates to supply AC power to facility connected electrical loads 165, the supplied AC power comprising power from one or more of power generation system 110, grid tie inverter 150 and electrical utility power source 180.

An operating methodology associated with the system 100 of FIG. 1 will now be described with respect to the below steps, each of which is indicated in FIG. 1 by a corresponding circled number.

Step 1. Natural Gas, Methane, #2 Fuel Oil, or Diesel Fuel can be used to power Turbine Generators or Combustion Engine Generators that produce electricity and synchronize with the utility electrical system by the use of an inverter at unity power factor.

Step 2. The exhaust from the Turbine Generators or Combustion Engine Generators Heat circulated water through manifolds or engine water jackets.

Step 3. Additional energy is recovered from the Turbine Generators or Combustion Engine Generators exhaust systems through the use of an air over water secondary heat exchanger that is incorporated with the same hot water closed loop system as the manifolds or the water jackets.

Step 4. Additional energy can be recovered from other building systems through the use of a water/steam over water secondary heat exchanger, Geothermal Sources, or Solar Collectors that are incorporated with the same hot water closed loop system as the Turbine Generators or Combustion Engine manifolds or water jackets.

Step 5. The temperature of the hot water closed loop system is regulated at 180 degrees F. by the use of variable frequency drive (VFD) controlled circulating pumps. The temperature is a function of the water flow in the system. The flow of the water is regulated by the rpm of the circulating pumps. The VFDs are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic DC Generator Engine is at approximately 150 degrees F.

Step 6. The 180-degree F. water is circulated through a Thermal Hydraulic DC Generator Engine. The water is used to expand liquid carbon dioxide which in turn drives a piston in one direction. A solenoid valve that is controlled by the PLC based control system controls the water flow. The liquid carbon dioxide does not experience a phase change. The Thermal Hydraulic DC Generator Engine does not involve an intake and exhaust cycle. It is very efficient and has a very long life expectancy with minimal maintenance requirements.

Step 7. An 80-degree F. cooling-water closed loop system is also required to operate the Thermal Hydraulic DC Generator Engine. This cooling-water loop is circulated through a sanitary water over water heat exchanger that is installed in the domestic water system or through a water over water heat exchanger that is connected to a cooling tower or a cooling water piping system in the ground. The domestic water temperature is usually around 70-80 Degrees F. The cooling water that returns from the Thermal Hydraulic DC Generator Engine is at approximately 100 degrees F.

Step 8. The temperature of the cooling water closed loop system is regulated by the use of variable frequency drive controlled circulating pumps. The temperature is a function of the water flow in the system. The flow of the water is regulated by the rpm of the circulating pumps. The VFDs are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic DC Generator Engine is at approximately 170 degrees F.

Step 9. The 80-degree F. water is circulated through a Thermal Hydraulic DC Generator Engine. The water is used to contract liquid carbon dioxide, which in turn drives a piston in the opposite direction from expanded liquid carbon dioxide. A solenoid valve that is controlled by a PLC based control system controls the water flow.

Step 10. The Thermal Hydraulic DC Generator Engine drives a hydraulic pump. The pistons moving back and forth pump hydraulic fluid. The flow of the hydraulic fluid is regulated by PID loops in the PLC based control system. The PLC program coordinates the opening and closing of the solenoid valves for the heating and cooling water loops with the required flow rate of the hydraulic fluid.

Step 11. The hydraulic pump drives a DC generator. The DC generator is connected to a grid tie inverter which synchronizes with the building electrical system at unity power factor. This device is referred to as a “Thermal Hydraulic DC Generator.”

Step 12. Additional “Green Energy” systems can be connected to the same grid tie inverter in order to synchronize with the building electrical system. These systems can include solar photovoltaic modules and wind Turbine systems.

Step 13. Revenue metering is established to monitor the power sold to the utility when the total generation exceeds the demand for the building systems.

Step 14. In cases where revenue metering is not allowed by the utility, the number of Micro Turbines that are synchronized to the building electrical system can be controlled by the PLC based control system. In this case the demand for the building will have to exceed the total amount of power that is generated.

In various embodiments, the PLC based control system performs the following functions:
1. Regulate the temperatures, pressures and flow rates for the heating cycle and cooling cycle water system.
2. Regulate the temperatures, pressures and flow rates for the hydraulic systems.
3. Control the firing rate of the solenoid valves to regulate the engine speed.
4. Control the inverter output.
5. Control associated generation systems.
6. Monitor the electrical system load demand.
7. Communicate with multifunction relays associated with the utility service.
8. Data Collection System
9. Alarm system

In various embodiments, the PLC based control system utilizes the following devices:
1. 32 bit microprocessor
2. Analog Input Module
3. Analog Output Module
4. Discrete Input Module
5. Discrete Output Module
6. RTD Temperature Sensors
7. Differential Pressure Transmitters
8. Flow Meters
9. Variable Frequency Drives
10. Multifunction Protective Relays
11. Current Sensors
12. Voltage sensors
13. Frequency Sensors
14. Operator Interface Terminal
15. Data Collection System
16. Alarm System

FIG. 2 graphically depicts physical dimensions of an exemplary Programmable Logic Controller (PLC) suitable for use as a controller within the system of FIG. 1. In various embodiments, the PLC comprises a 32 bit microprocessor-based PLC with Ethernet communications, such as the model 1769-L32C or 1769-L35CR CompactLogix Controller manufactured by Rockwell Automation. It can be seen by inspection that the exemplary PLC 200 of FIG. 2 includes various connection an interface elements such as central processing unit (CPU) connectors 210, control network connectors 220, channel input/output connectors 230, user or operator input/output interface devices 240 and the like. Generally speaking and as known in the art, the PLC 200 of FIG. 2 comprises a device including a processor, memory and input/output circuitry which may be programmed to monitor various digital and/or analog input signals and responsively adapts various output signal levels or data/communication sequences in response to such monitoring.

FIG. 3 graphically depicts exemplary power and signal input terminals associated with the PLC of FIG. 2. Specifically, FIG. 3 represents a discrete input module used for the PLC based control system. It can be seen by inspection that the power terminals are responsive to a line or grid voltage of 100/120 VAC (in this embodiment) and that various input devices may be coupled to the signal input terminals.

FIG. 4 graphically depicts exemplary signal output terminals associated with the PLC of FIG. 2. Specifically, FIG. 4 represents a discrete output module for the PLC based control system comprising, illustratively, a 16-point AC/DC Relay Output Module. It can be seen by inspection that the relay output module is adapted to be grounded in a particular manner.

FIG. 5 graphically depicts an exemplary wiring configuration for connecting sensors/transmitters to signal input terminals associated with the PLC of FIG. 2. Specifically, FIG. 5 represents an analog input module for the PLC based control system. FIG. 5 is divided into two sub-figures; namely, FIG. 5A and FIG. 5B.

FIG. 5A graphically depicts an exemplary wiring configuration for connecting single-ended sensor/transmitter types to signal input terminals associated with the PLC of

FIG. 2. It can be seen by inspection that a sensor/transmitter power supply 510 cooperates with a current sensor/transmitter 520 and a plurality of voltage sensor/transmitters 530. The current sensor/transmitter 520 provides an output signal adapted in response to a sensed parameter, which output signal is provided to a current sensor input terminal (I in 0+) of a terminal block 540. The voltage sensor/transmitters 530 provide output signals adapted in response to respective sensed parameters, which output signals are provided to respective voltage sensor input terminals (V in 2+ and V in 3+) of the terminal block 540.

FIG. 5B graphically depicts an exemplary wiring configuration for connecting mixed transmitter types to signal input terminals associated with the PLC of FIG. 2. It can be seen by inspection that a sensor/transmitter power supply 510 cooperates with a single ended voltage sensor/transmitter 530, a differential voltage sensor/transmitter 550, a differential current sensor/transmitter 560 and a 2-wire current sensor/transmitter 570. Each of the sensor/transmitter types 530, 550, 560 and 570 provides an output signal adapted in response to a respective sensed parameter, which output signal is provided to a respective input terminal of a terminal block 540.

FIG. 6 graphically depicts an exemplary wiring configuration for connecting an output device to signal output terminals associated with the PLC of FIG. 2. Specifically, FIG. 6 represents an analog output module for the PLC based control system. It can be seen by inspection that an optional external 24 V DC power supply is connected between an DC neutral terminal and a +24 VDC terminal of a terminal block 640, while a shielded cable 620 provides current to a load (not shown) load, the current sourced from a current output terminal (I out 1+) of the terminal block 640.

FIG. 7 graphically depicts an exemplary wiring configuration for connecting a Resistance Temperature Detector (RTD) to excitation and sense input terminals of the PLC of FIG. 2. Specifically, FIG. 7 represents an RTD input module for the PLC based control system. FIG. 7 is divided into two sub-figures; namely, FIG. 7A and FIG. 7B.

FIG. 7A graphically depicts an exemplary wiring configuration for connecting a 2-wire Resistance Temperature Detector (RTD) to excitation and sense input terminals of the PLC of FIG. 2. It can be seen by inspection that an RTD 710 is coupled between bridged excitation (EXC 3) and sense (SENSE 3) terminals at a terminal block 740, and a return terminal (RTN 3) at the terminal block 740. Current sourced from the excitation/sensor terminals passes through the RTD 710 and returns to the return terminal. It is also noted that a two-conductor shielded cable, illustratively a Belden 9501 Shielded Cable, is used to connect the excitation/sense wire (RTD EXC) and return wire (Return) between the RTD 710 and terminal block 740. The shield of the shielded cable is coupled to ground.

FIG. 7B graphically depicts an exemplary wiring configuration for connecting a 3-wire Resistance Temperature Detector (RTD) to excitation (EXC 3), sense (SENSE 3) and return (Return) terminals at a terminal block 740 of the PLC of FIG. 2. It can be seen by inspection that an RTD 710 is coupled between a junction or connection 0.706 proximate the RTD 710 of an excitation signal wire (RTD EXC) and a sense signal wire (Sense), and a return signal wire (Return). It is also noted that a three-conductor shielded cable, illustratively a Belden 83503 or 9533 Shielded Cable, is used to connect the excitation wire (RTD EXC), sense wire (sense That) and return wire (Return) between the RTD 710 and terminal block 740. The shield of the shielded cable is coupled to ground.

FIG. 8 graphically depicts physical dimensions of an exemplary user interface device associated with the PLC of FIG. 2. Specifically, FIG. 8 represents an operator interface terminal 800 used for the PLC based control system. FIG. 8A depicts a front view of the operator interface terminal 800, while FIG. 8B depicts a plan view of the operator interface terminal 800. It can be seen by inspection that the exemplary operator interface terminal 800 comprises a PanelView Plus 400 or 600 terminal manufactured by Allen-Bradley. The terminal 800 includes a keypad or keypad/touch screen 810/820. Generally speaking, the terminal includes circuitry supporting user input to the PLC (e.g., keypad or touch screen input), as well as circuitry providing user output from the PLC (e.g., display screen). As is known in the art, the terminal 800 is used to facilitate programming of the various functions of the PLC 200, such as those described herein as implemented via the PLC 200 and the various embodiments. It is also noted that the terminal includes various network and communication ports 830 as shown in

FIG. 9 graphically depicts physical dimensions for various VFDs suitable for providing circulation pump control functionality in the system of FIG. 1 in cooperation with the PLC of FIG. 2. FIG. 9 represents a VFD used for circulation pump control with the PLC based control system, illustratively one of the PowerFlex 70 frames manufactured by Rockwell Automation. FIG. 9A depicts a table listing output power for various PowerFlex 70 frame sizes. FIGS. 9B and 9C depict physical dimensions associated with PowerFlex 70 Frames A-D as indicated in the table of FIG. 9A. FIG. 9C depicts a table listing physical mounting options associated with various PowerFlex 70 frame sizes.

FIG. 10 depicts a schematic diagram of an exemplary inverter suitable for use as a grid tie inverter within the system of FIG. 1. Specifically, FIG. 10 represents a grid tie inverter. The grid tie inverter 150 of FIG. 10 is used to convert DC power to AC Power and synchronize the AC power with the utility power grid at unity power factor. Referring to FIG. 10, components associated with grid tie inverter 150 are configured as follows:

A DC input voltage is received across an input capacitor C1. A first inductor L1 and a first transistor Q1 (illustratively an N-channel IGFET) are connected in series in the order named between positive and negative terminals of the input capacitor C1.

A forward biased diode D1 and second capacitor C2 are connected in series in the order named between a source and a drain of transistor Q1 (i.e., anode of diode D1 connected to source of transistor Q1, cathode of diode D1 connected to positive terminal of capacitor C2).

A first switching circuit SW1 connected between positive and negative terminals of capacitor C2 operates to switch or chop the voltage across capacitor C2. The switching circuit SW1 comprises, illustratively, four transistors Q2-Q5 (illustratively an N-channel IGFETs) configured in a known manner to drive a switched power signal through a input coil of a transformer T1.

An output coil of transformer T1 provides a resulting switched or chopped signal to a full wave bridge rectifier B1 formed in a known manner using four diodes D2-D5 to provide thereby a rectified (i.e., substantially DC) signal.

A second inductor L2 and a third capacitor C3 are connected in series in the order named between positive and negative outputs of the full wave bridge rectifier B1.

A second switching circuit SW2 connected between positive and negative terminals of capacitor C3 operates to switch or chop the voltage across capacitor C3. The switching circuit SW1 comprises, illustratively, four transistors to 6-29 (illustratively an NPN transistors having respective diodes forward biased between emitter and collector terminals.) configured in a known manner to a series drive a switched power signal through a third inductor L3 and a fourth capacitor C4, L3 and C4 being connected in series in the order named.

An inductive element Lgrid (representative of power grid inductance), a switch SW and the power grid itself are connected in series in the order named between positive and negative terminals of capacitor C4.

An AC output signal between the Lgrid/SW junction point and the negative terminal capacitor C4 is provided as an AC output to the main panel.

Referring to FIGS. 1 and 10, various operations of the grid tie inverter 150 within the context of the system 100 will now be described.

Operating a renewable energy system in parallel with an electric grid requires special grid interactive or grid tie inverters (GTI). The power processing circuits of a GTI are similar to that of a conventional portable power inverter. The main differences are in their control algorithm and safety features.

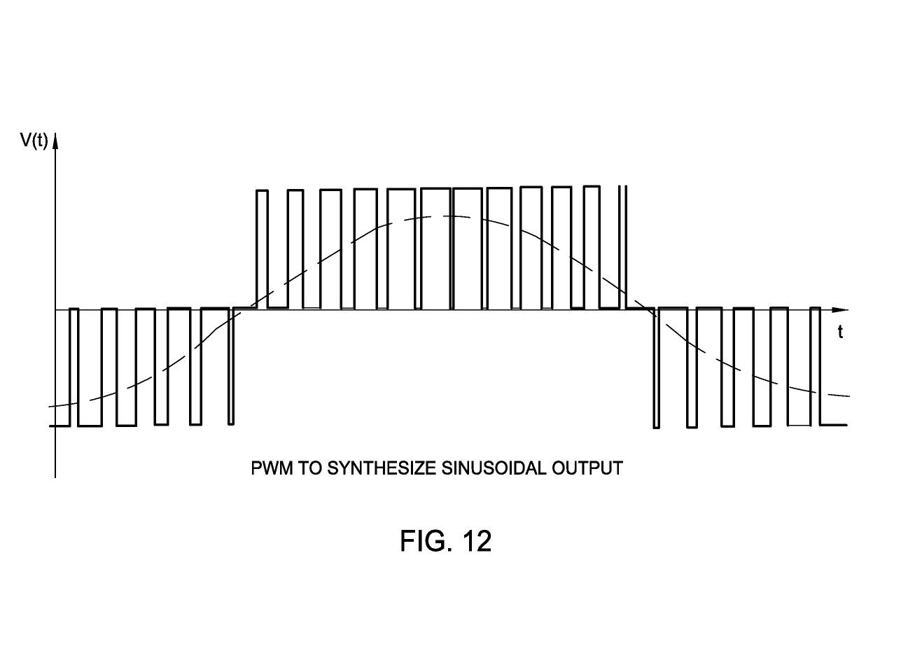

A GTI typically takes the DC voltage from the source, such as an solar panels array or a wind system, and inverts it to AC. It can provide power to your loads and feed an excess of the electricity into the grid. The GTIs are normally two-stage or three-stage circuits. The simplified schematic diagram shown in FIG. 12 illustrates the PWM to sinusoidal waveshape operation of a grid tie inverter with three power stages. Such power train can be used for low-voltage inputs (such as 12V). The control circuits and various details are not shown here.

The DC input voltage is first stepped up by the boost converter formed with inductor L1, MOSFET Q1, diode D1 and capacitor C2. If PV array is rated for more than 50V, one of the input DC busses (usually the negative bus) has to be grounded per National Electric Code®.

Since the AC output is connected to the grid, in such case the inverter has to provide a galvanic isolation between the input and output. In our example the isolation is provided by a high frequency transformer in the second conversion stage. This stage is a basically a pulse-width modulated DC-DC converter. Note that some commercial models use low-frequency output transformer instead of a high frequency one. With such method low voltage DC is converted to 60 Hz AC, and then a low-frequency transformer changes it to the required level. The schematic above shows a full bridge (also known as H-bridge) converter in the second stage. For power levels under 1000 W it could also use a half-bridge or a forward converter. In Europe, grounding on DC side is not required, the inverters can be transformerless. This results in lower weight and cost.

The transformer T1 can be a so-called step-up type to amplify the input voltage. With a step-up transformer, the first stage (boost converter) may be omitted. The isolating converter provides a DC-link voltage to the output AC inverter. Its value must be higher than the peak of the utility AC voltage. For example, for 120 VAC service, the DC-link should be >120*√2=168V. Typical numbers are 180-200V. For 240 VAC you would need 350-400 V.

The third conversion stage turns DC into AC by using another full bridge converter. It consists of IGBT Q6-Q9 and LC-filter L3, C4. The IGBTs Q6-Q9 work as electronic switches that operate in Pulse Width Modulation (PWM) mode. They usually contain internal ultrafast diodes. By controlling different switches in the H-bridge, a positive, negative, or zero voltage can be applied across inductor L3. The output LC filter reduces high frequency harmonics to produce a sine wave voltage.

A grid tie power source (i.e., grid tie inverter 150) operates to synchronize its frequency, phase and amplitude with the utility and feed a sine wave current into the load. Note that if inverter output voltage (Vout) is higher than utility voltage, the GTI will be overloaded. If it is lower, GTI would sink current rather than source it. In order to allow the electricity flow back into the grid, “Vout” has to be just slightly higher than the utility AC voltage. Usually there is an additional inductor (Lgrid) between GTI output the grid that “absorbs” extra voltage. It also reduces the current harmonics generated by the PWM. A drawback of “Lgrid” is it introduces extra poles in the control loop, which may lead to the system instability.

In solar applications, to maximize the system efficiency, a GTI has to meet certain requirements defined by the photovoltaic panels. Solar panels provide different power in different points of their volt-ampere (V-I) characteristic. The point in the V-I curve where output power is maximum is called maximum power point (MPP). The solar inverter must assure that the PV modules are operated near their MPP. This is accomplished with a special control circuit in the first conversion stage called MPP tracker (MPPT).

A GTI also has to provide so-called anti-islanding protection. When grid fails or when utility voltage level or frequency goes outside of acceptable limits, the automatic switch SW quickly disconnects “Vout” from the line. The clearing time must be less than 2 seconds as required by UL 1741.

The implementation of control algorithm of grid tie inverters is quite complex implemented with microcontrollers.

FIG. 11 graphically depicts a generator suitable for use within the system of FIG. 1. Specifically, FIG. 11 represents a DC generator used to generate DC power.

Various embodiments provide a novel Thermal Hydraulic DC Generator. The inventor notes that a person in the relevant technical field would think that it would not be possible to use this combination of devices for the following reasons:

People in this field would not realize that the regulation of the hydraulic fluid in the Thermal Hydraulic DC Generator Engine to drive the Thermal Hydraulic DC Generator RPM at the correct speed could be achieved. This will eliminate the need for a regulator and a an engine speed governor that is typically required for an engine/generator package. This will require a PLC based control system with the correct instrumentation devices.

People in this field would not realize that the regulation of the DC Generator and the output of the inverter to match the load demands could be achieved. This will require a PLC based control system with the correct instrumentation devices.

People in this field would not realize that the regulation of pressures, temperatures, and flow rates for the closed loop hot water and cooling water systems could be achieved in a steady manner. This will require a PLC based control system with the correct instrumentation devices.

People in this field would not realize that it is economically feasible to implement this system. The efficiency of the Thermal Hydraulic DC Generator is much better than anything else available for this type of application. This is new technology and people in the field are not aware of its capabilities.

People in this field would not realize that so much energy is wasted in turbine generator exhaust systems. They would not realize that so much energy can be recovered and used to generate additional electricity with a Thermal Hydraulic DC Generator at such a low cost. Again, this is new technology, and people in the field are not aware of its capabilities.

People in this field would not realize that the Thermal Hydraulic DC Generator system meets “Green Energy” requirements. “Green Energy” qualifies for tax credits and can add to the savings when this type of system is installed. Again, this is new technology, and people in the field are not aware of its capabilities.

People in this field would not realize that so much energy can be wasted from utility steam systems that enter large buildings in lots of cities around the world. They would not realize that so much energy can be recovered and used to generate additional electricity with a Thermal Hydraulic DC Generator at such a low cost. Again this is new technology, and people in the field are not aware of its capabilities.

People in this field would not realize that this system is very flexible and can incorporate other forms of Green Energy sources through the use of a common inverter.

People in this field would not realize that the use of the DC Generator and the inverter to generate electricity at unity power factor can increase the efficiency of the system.

In various embodiments, waste energy is recovered from Turbine Generator or Combustion Engine Generator Exhaust Systems to produce hot water for co-generation to drive Thermal Hydraulic DC Generators.

In various embodiments, waste steam is recovered from utility systems to drive Thermal Hydraulic DC.

In various embodiments, energy from Combustion Engine Cooling Water Systems is recovered to produce hot water to drive Thermal Hydraulic DC Generators.

In various embodiments, the use of Solar Collectors is incorporated in conjunction with Thermal Hydraulic DC Generators. The Solar Collectors produce hot water to drive the Thermal Hydraulic DC Generators.

Various embodiments incorporate the use of Geothermal Sources in conjunction with Thermal Hydraulic DC Generators. The Geothermal Sources produce hot water to drive the thermal Hydraulic DC Generators.

Generally speaking, the various embodiments are described above within the context of systems, methods, apparatus and so on using Thermal Hydraulic DC

Generators. However, various other embodiments are contemplated in which the Thermal Hydraulic DC Generator is replaced by (or augmented by) one or both of a Thermal Hydraulic Induction Generator or a Thermal Hydraulic Synchronous Generator. Other types of thermal hydraulic generators may also be used in various embodiments.

Some types of thermal hydraulic generators provide a DC output signal, such as the Thermal Hydraulic DC Generator 130 described above with respect to FIG. 1. Other types of thermal hydraulic generators provide an AC output signal, such as Thermal Hydraulic Induction Generators and Thermal Hydraulic Synchronous Generators.

Within the context of thermal hydraulic generators providing a DC output signal, a DC to AC conversion is provided such that power generated by the thermal hydraulic generator may be used by, for example, the facility electrical system switchgear 160, facility connected electrical loads 165 and/or electrical utility power source 180 as described above with respect to FIG. 1.

In the embodiments described above with respect to FIG. 1, DC to AC conversion of the output of thermal hydraulic DC generator 130 is provided via grid tie inverter 150.

Within the context of thermal hydraulic generators providing an AC output signal, an AC to DC to AC conversion may be provided to ensure that power generated by the thermal hydraulic generator may be used. For example, depending upon the type of AC-output thermal hydraulic generator used, changes to voltage level, phase, frequency, and so on associated with the AC power signal provided by the thermal hydraulic generator may be appropriate such as to enable synchronization with AC power received from the local electrical grid (e.g., electrical utility power source 180). In embodiments where the above-described thermal hydraulic DC generator (e.g., thermal hydraulic DC generator 130) is replaced by a thermal hydraulic induction generator or a thermal hydraulic synchronous generator, the DC to AC converter (e.g., grid tie inverter 150) is not used to process the output of the thermal hydraulic generator. Instead, an AC to DC to AC converter (if necessary) to ensure that the power output signal provided by the thermal hydraulic induction generator or thermal hydraulic synchronous generator is appropriately conditioned for use by, illustratively, facility electrical system switchgear 160, facility connected electrical loads 165 and/or electrical utility power source 180. Preferably, the AC to DC to AC converter operates at a unity power factor.

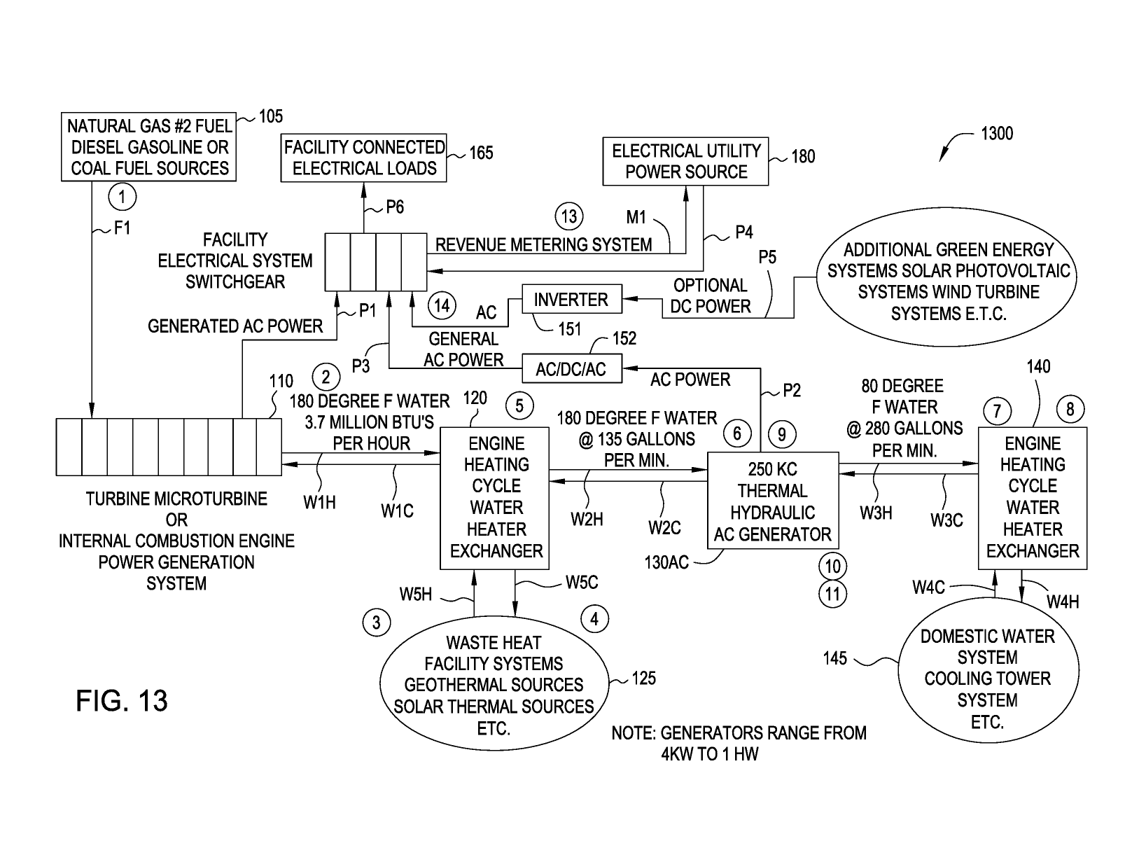

FIG. 13 depicts a high level block diagram of a system according to an embodiment. Generally speaking, FIG. 13 depicts a flow diagram for a Thermal Hydraulic AC Generator connected to a microturbine system to capture waste heat from the exhaust and increase the efficiency of the overall system. Since the system 1300 of FIG. 13 is substantially similar to the system 100 described above with respect to FIG. 1, only the various differences between the two systems will be described in detail.

A primary difference is that the system 1300 of FIG. 13 is adapted to use a thermal hydraulic AC generator 130AC rather than a thermal hydraulic DC generator 130 of FIG. 1. In addition, the system 1300 uses as a power conditioner an AC to DC to AC converter 152 (if necessary), rather than the grid tie inverter 150, to synchronize the AC power of the with the thermal hydraulic AC generator 130AC with the utility power grid at unity power factor

In various embodiments, such as where additional green energy systems 170 are used to provide optional DC power, an inverter 151 is used within the system 1300 of FIG. 13 to provide additional AC power to the facility electrical system switchgear 160.

In addition to the structural differences discussed herein with respect to the system 1300, other control loop modifications are also made to ensure that the AC power ultimately provided to the facility electrical system switchgear, facility electrical components, local grid and so on is properly conditioned and controlled.

Thus, the systems 100 of FIG. 1 and 1300 of FIG. 13 provide a power conditioner (i.e., grid tie inverter 150, inverter 151 and/or AC/DC/AC converter 152) appropriate to the DC or AC output of whichever thermal hydraulic generator is used. The power conditioner receives the output power from the generator and operates to synchronize its frequency, phase and amplitude with the utility and feed a sine wave current into the load. Note that if the power conditioner output voltage (Vout) is higher than utility voltage, the power conditioner will be overloaded. If it is lower, power conditioner would sink current rather than source it. In order to allow the electricity flow back into the grid, “Vout” has to be just slightly higher than the utility AC voltage. Usually there is an additional inductor (Lgrid) between the output and the grid that “absorbs” extra voltage. This also reduces the current harmonics generated by internal power conditioner circuitry, such as pulse width modulators (PWMs) and the like. A drawback of “Lgrid” is that it introduces extra poles in the control loop, which may lead to the system instability.

Generally speaking, the power conditioner is controlled in a similar manner to that described above with respect to the grid tie inverter 150 in that the power conditioner converts the output power of the generator into AC power for use by an electrical load. The generator is responsive to a control signal indicative of electrical system load demand associated with the electrical load to adapt its output power such that the power conditioner satisfies the electrical system load demand.

In solar applications, to maximize the system efficiency, a power conditioner has to meet certain requirements defined by the photovoltaic panels. Solar panels provide different power in different points of their volt-ampere (V-I) characteristic. The point in the V-I curve where output power is maximum is called maximum power point (MPP).

The solar inverter must assure that the PV modules are operated near their MPP. This is accomplished with a special control circuit in the first conversion stage called MPP tracker (MPPT).

A power conditioner also has to provide so-called anti-islanding protection. When grid fails or when utility voltage level or frequency goes outside of acceptable limits, the automatic switch SW quickly disconnects “Vout” from the line. The clearing time must be less than 2 seconds as required by UL 1741.

It is also noted that water temperatures and other operational characteristics may be different between various DC and AC generators. For example, the thermal hydraulic DC generator may provide water having temperature of 150° F. whereas a thermal hydraulic AC generator may provide water having a temperature of 170° F. The system 1300 of FIG. 13 is adapted in response to these and other differences between the operation of the various DC and AC generators.

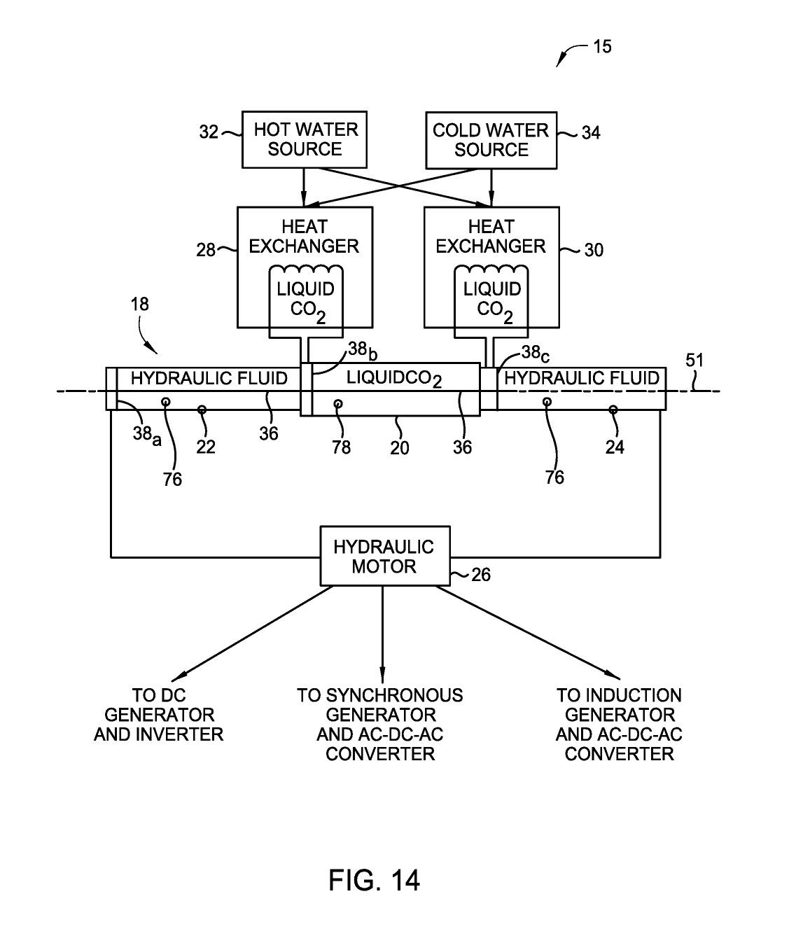

Thus, generally speaking, the various embodiments provide a mechanism wherein any of a thermal hydraulic DC generator or thermal hydraulic AC generator may be utilized to provide power to a local electrical grid, facility electrical components, facility electrical switching equipment and the like. The output power signal of the AC or DC thermal hydraulic generator is conditioned as necessary such as via an inverter (if DC generator) or an AC/DC/AC converter (if AC generator) such that a resulting conditioned output power signal is appropriate for use by the local electrical grid, facility electrical components, facility electrical switching equipment and the like. FIGS. 14-16 describe further embodiments illustrating more efficient and stable operation of thermal hydraulic generators and heat exchangers.

FIG. 14 show a block diagram of a system 15 comprising a full cycle thermal hydraulic generator 18 (also see generators 130 and 130AC in FIGS. 1 and 13) including heat exchangers 28 and 30, hot and cold water sources 32 and 34, and a hydraulic motor 26, according to one embodiment. This block diagram depicts only main components important for presenting novel features described herein. Many other components like valves, flow meters, transformers, pumps and variable frequency drivers for pumps, instrumentation for storing liquid CO₂ and hydraulic fluid, and the like are not shown in FIG. 14. These components would be obvious to a person skilled in the art. All of the instrumentation for the system 15, shown or not shown in FIGS. 14-16 may be controlled by the control system (e.g., using PLC) already described herein.

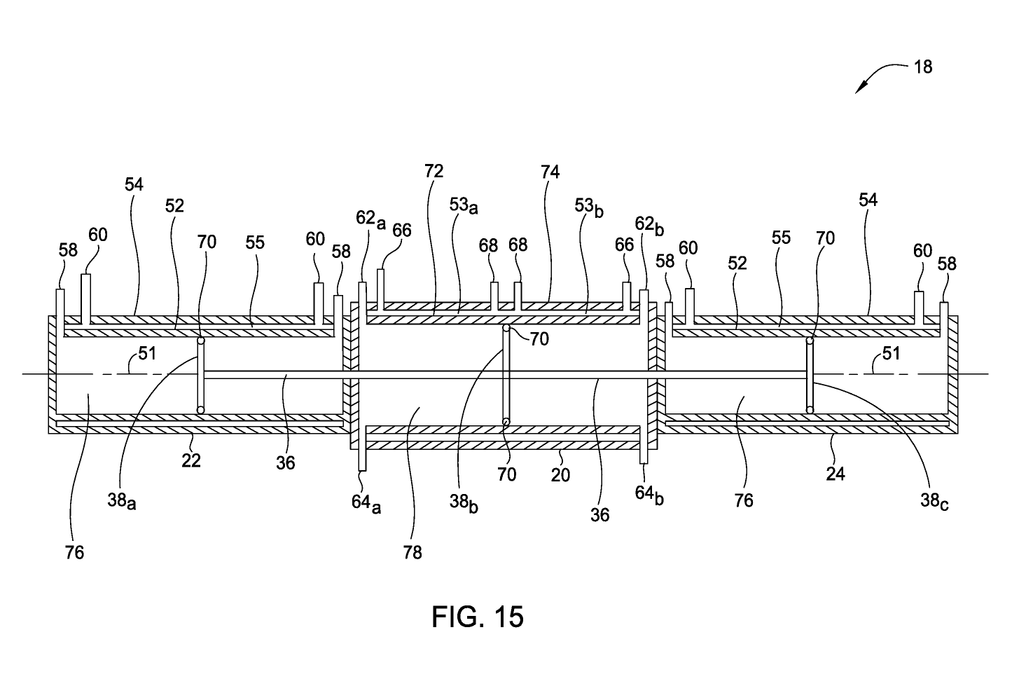

The thermal hydraulic generator 18 is shown in FIG. 15 in detail, so the description provided below in reference to the generator 18 refers to both FIGS. 14 and 15.

According to one embodiment, the thermal hydraulic generator (or assembly) 18 comprises an assembly of three chambers 20, 22 and 24 each having a cylindrical elongated shape. The chamber 20 is built around an axis and comprises an internal cavity 78, located inside of the chamber 20 and having an outer wall (casing 72) through a length of the chamber 18, including at least two inlets (62a and 62b) for entering a liquid such as liquid CO₂ into the internal cavity. The liquid (e.g., CO₂) may be maintained in the internal cavity 78 in a liquid state using predefined combinations of pressures and temperature, where a temperature of the liquid (or its portions) can be alternated between preselected two temperatures (e.g., approximately 80F and 180F for CO₂ implementation) during operation of said thermal hydraulic generator 18. When the liquid CO2 is heated to 180F, it expands, whereas when the liquid CO2 is cooled to 80F, it contracts.

According to a further embodiment, the internal cavity 78 may further comprise at least two outlets 64a and 64b, so that the liquid entered through the first or second inlet 62a or 62b can circulate through a corresponding first or second outlet 64a or 64b for faster temperature stabilization of the corresponding liquid portions, wherein one liquid circulating pair comprises the first inlet 62a and the first outlet 64a located near one end of the internal cavity 78 and another liquid circulating pair comprises the second inlet 62b and the second outlet 64b located near an opposite end of the internal cavity 78.

The two chambers 22 and 24 are two hydraulic fluid chambers, each built around a further axis, and having a further internal cavity 76, located inside of the hydraulic fluid chamber 22 or 24 and having an outer wall (casing 52) through a length of the hydraulic fluid chamber 22 or 24, including at least two inlets/outlets 58 and 60 for moving a hydraulic fluid in and out of the further internal cavity 76.

Moreover, these three chambers 20, 22 and 24 are rigidly attached to each other at respective ends with the chamber 20 being in between the two hydraulic fluid chambers 22 and 24 (e.g., a first end of the chamber 20 is attached to one end of a first hydraulic fluid chamber 22 and a second end of the chamber is attached to one end of a second hydraulic fluid chamber 24, such that the axis of the chamber 20 and further axes of the two hydraulic fluid chambers 22 and 24 forming a common axis 51 with a continuous moving shaft 36 inserted in this assembly 18 of the chambers 20, 22 and 24.

The shaft 36 has three pistons 38 shaped as round thin plates and rigidly connected to the shaft 36 in predefined positions with surfaces of the three round plates being perpendicular to the common axis 51. It is seen from FIGS. 14 and 15 that two pistons 38a and 38c are positioned at respective ends of the shaft 36, so that when the shaft 36 is in a middle position in the assembly 18, each of the two pistons 38a and 38c is located approximately in the middle of the corresponding first and second hydraulic fluid chambers 22 and 24 and a third piston 38b is located approximately in the middle of the chamber 20. Each piston 38a, 38b or 38c separates into two portions a corresponding liquid or fluid in each of the corresponding chambers 20, 22 and 24 of the assembly 18.

Furthermore, each piston 38a, 38b or 38c comprises an O-ring on its outside perimeter and is in contact with corresponding outer walls (casings) 52 and 72 in the corresponding internal cavities 78 and 76 providing, when the shaft 36 moves, a smooth sliding of the corresponding pistons 38a, 38b and 38c with O-rings 70 along the outer walls 52 and 72 of corresponding internal cavities 78 and 76 in these three chambers 20, 22 and 24.

According to an embodiment, a principle of operation of the thermal hydraulic generator 18 is described as follows. As stated above in reference to FIG. 15, the internal cavity 78 of the chamber 20 comprises two inlets 62a and 62b located at opposite ends of the internal cavity 78. Then during a first half of a time cycle, one of the two inlets (e.g., 62a) can be used to enter the liquid having a high temperature expansion coefficient at a low preselected temperature (such as 80F for the liquid CO₂) and another inlet (e.g., inlet 62b) can be used to enter the same liquid at a high preselected temperature (such as 180F for the liquid CO₂), so that the piston 38b separating liquids having low and high preselected temperatures is moved in a direction of the internal cavity portion comprising the liquid at the low preselected temperature (piston 38b moves toward the inlet 62a) due to a higher expansion coefficient of the liquid (CO2) having the high preselected temperature. The shaft 36 (rigidly connected to the pistons) moves in the same direction as the piston 38b further causing the pistons 38a and 38c to be moved in the same direction due to rigidity of the shaft construction and to move the hydraulic fluid located in the hydraulic fluid chambers 22 and 24.

Moreover, during a second half of a time cycle, temperatures of the liquid provided to the two inlets 62a and 62b are reversed, so that the piston 38b separating liquids having the low and high preselected temperatures is moved in an opposite direction (piston 38b moves toward the inlet 62b), thus simultaneously moving in the same opposite direction the pistons 38a and 38b and the hydraulic fluid located in the hydraulic fluid chambers 22 and 24.

The full time cycle for the generator 18 may be approximately 10 seconds. It can be improved by using circulation of the liquid (CO₂) provided to the inlets 62a and 62b through the corresponding outlets 64a and 64b for faster temperature stabilization at a desired temperature of the corresponding liquid portions, as described above.

The movement of the hydraulic fluid during the first and second time cycles described herein, may provide a power to a hydraulic motor 26 (shown in FIG. 14) during both time cycles, thus maximizing efficiency of the thermal hydraulic generator 18 compared to a conventional half cycle thermal hydraulic generator.

According to a further embodiment, the hydraulic motor 26 may be used for generating an electric power during both the first and second time cycles using a DC generator with an inverter, an induction generator with an AC-DC-AC convertor or a synchronous generator with the AC-DC-AC convertor, as described herein in reference to FIGS. 1 and 13.

In the examples shown in FIGS. 14 and 15 one possible liquid with a high temperature expansion coefficient to use in the internal cavity 78 of the chamber 20, among other possible candidates, may be the liquid CO₂ with two alternating temperatures (e.g., approximately 80F and 180F). According to a further embodiment, additional outer chamber(s) 53a and 53b around the internal cavity 78 in the chamber 20 may be used for circulating a fluid (e.g., a water) to maintain the liquid in the internal cavity 78 in a liquid state and to accelerate cooling of the liquid from the high preselected temperature (e.g., 180F for CO₂) to the low preselected value (e.g., 80F for the liquid CO₂) during operation of the system 15.

Moreover, each outer chamber 53a and 53b may have its own inlets/outlet 66 and 68 respectively. In alternative implementation chambers 53a and 53b may be combined into one outer chamber. The temperature of the circulating fluid (such as water) in the chambers 53a and 53b may be in a range between 80 F and 100 F to maintain the liquid such as CO₂ in the internal cavity 78 in the liquid state and to accelerate cooling of that liquid to the low temperature 80F during operation. Similarly, outer chambers 55 for circulating the fluid (such as water) through inlet/outlet 58 and 60 may be used in the hydraulic fluid chambers 22 and 24 for stabilizing their operation.

As stated above, the liquid is provided to each of the two inlets 62a and 62b by one of the two heat exchangers 28 and 30 shown in FIG. 14, where each of the heat exchangers 28 and 30 alternates a liquid temperature between the low (e.g., 80F) and high (e.g., 180F) preselected temperatures. Sources of hot (e.g., 180F) and cold (e.g., 80F) water 32 and 34 respectively, can provide alternatively (switches are not shown in FIG. 14) in each half time cycle the water at different temperatures to the corresponding heat exchanges 28 and 30 to heat or to cool the liquid (e.g., CO2) provided to the corresponding inlets 62a and 62b of the chamber 22, as explained herein. Heat exchangers 28 and 30 are operated in anti-phase in time domain. In other words, during the half time cycle when one of the heat exchanges 28 and 30 heats the liquid to the high preselected temperature, the other heat exchanger cools the liquid to the low preselected temperature.

In another embodiment the outer chambers 53a, 53b, 50 of each of the three chambers 20, 22 and 24 and their respective inlets and outlets may be rated at 100 PSI, and the internal cavity 78 and all inlets and outlets (62a, 62b, 64a and 64b) associated with the internal cavity may be rated at 2000 PSI.

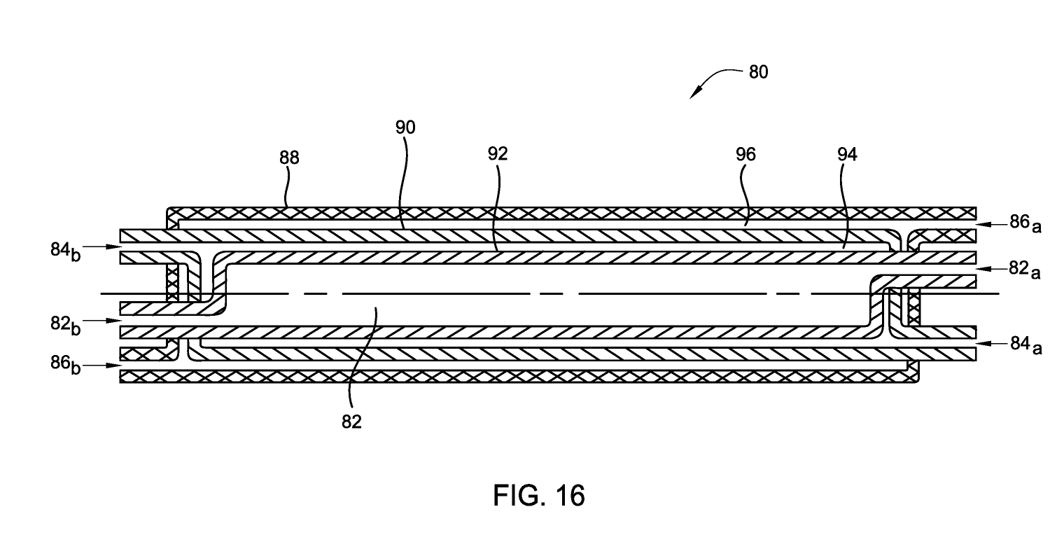

FIG. 16 shows a block diagram of a heat exchanger or chamber 80 (also shown as the heat exchanger 28 or 30 in FIG. 14) having a cylindrical elongated shape, according to an embodiment. The heat exchanger 80 comprises an internal cavity 82 located inside of the heat exchanger 80 and having an outer wall 92 through a length of the heat exchanger 80, including at least one inlet 82a for entering a liquid (e.g., CO₂) into the internal cavity 82, and at least one outlet 82b for circulating and/or providing the liquid at alternating temperatures to the chamber 20 of the hydraulic fluid generator 18 as described herein. Further, the liquid is maintained in the internal cavity 82 in a liquid state using predefined combinations of pressures and temperatures, where a temperature of the liquid is alternated between two preselected temperatures (e.g., between 80F and 180F for the liquid CO₂).

According to a further embodiment, the heat exchanger 80 may comprise at least two outer chambers 94 and 96. The first outer chamber 94 is located around the internal cavity 82 through the length of the internal cavity 82 and being surrounded by an inner wall and an outer wall 90 having elongated cylindrical shapes such that the inner wall of the first outer chamber 94 is shared with an outer wall 92 of the internal cavity 82.

Chamber 94 can be used for circulating a fluid (e.g., water) through an inlet 84a and an outlet 84b at alternating temperatures, e.g., approximately 80F and 180F for the liquid CO₂, in order to control the temperature of the liquid such as liquid CO₂ in the internal cavity 82. The water may be provided to the first outer chamber of the heat exchanger 80 (also the heat exchanger 28 or 30 in FIG. 14) using a switching system (not shown in FIGS. 14 and 16, but known to a person skilled in the art) from the cold and hot water sources 32 and 24 respectively as shown in FIG. 14.

Chamber 96 can be further located around the outer chamber 96 through the length of the internal cavity 82 and being surrounded by an inner wall and an outer wall 88 having elongated cylindrical shapes such that the inner wall of the second outer chamber 96 is shared with an outer wall 90 of the first chamber 94.

Chamber 96 can be used for circulating a fluid (e.g., water) through an inlet 86a and an outlet 86b at a preselected temperature range, for example between 80F and 100 F to maintain the liquid in the internal cavity in the liquid state and to accelerate cooling of the liquid (e.g., from about 180F to about 80F) during operation of the heat exchanger 80. The water may be provided to the second outer chamber 96 of the heat exchanger 80 (e.g., the heat exchanger 28 or 30 in FIG. 14) using a switching system (not shown in FIGS. 14 and 16) from the cold and/or hot water sources 32 and 24 respectively as shown in FIG. 14.

It is further noted that outer chambers 94 and 96 and their respective inlets and outlets 84a, 84b, 86a and 86b may be rated at 100 PSI, and the internal cavity 82 and inlets and outlets 82a and 82b associated with the internal cavity 82 may be rated at 2000 PSI.

It is noted that functionality of the heat exchanger 80 with alternating high and low temperatures of the liquid (CO₂) in each exchanger is a further development of heat exchangers 120 and 140 described in reference to FIGS. 1 and 13, where each heat exchanger is dedicated to one (low or high) temperature.

Thermal Hydraulic Heat Pump for HVAC

The various embodiments described above with respect to FIGS. 1-16 are further adapted for use within the context of heating, ventilation and air conditioning (HVAC) applications by utilizing a particular type of thermal hydraulic heat pump rather than a thermal hydraulic generator, a particular control scheme and other improvements as will be discussed in more detail below.

Generally speaking, heat pump systems require the use of electric motors as the prime mover driving a rotary pump to move a heated or cooled medium for use in HVAC applications. In accordance with various embodiments, a system is provided which uses molecular expansion and contraction principles to drive linear pumping cylinders. The various embodiments use hot (e.g., 180 Degree F.) water systems incorporated in Thermal

Hydraulic Heat Pumps to provide improved efficiency over current systems that require electric motors to drive rotary pumps. The various embodiments incorporate a control system such as a PLC based control system that monitors and controls the temperature, pressure, and flow of the fluid mediums involved in the disclosed system, such as hot water, cold water, supercritical CO2 and transcritical CO2. Though described within the context of a PLC based control system, other controls systems may be used to provide the desired control functions, such as other specific purpose and/or general purpose computing systems programmed to achieve the desired functions.

In various embodiments, supercritical CO2 at 1600 pounds per square inch (psi) having a temperature of between 80-180° F. is used as a prime mover for the heat pump. In various embodiments, trans-critical CO2 at 1070 psi and 80° F. is used as a refrigerant. In various embodiments, other refrigerants such as ammonia or Freon may be used.

One of the technical innovations pertaining to the disclosed Thermal Hydraulic Heat Pump relates to regulating a flow of the transcritical CO2 refrigerant to an evaporator and a condenser and ensuring the correct output for the heat pump. The heating and cooling load demands of, illustratively, a building or other facility are matched through the PLC based control system and instrumentation. The PLC based control system also controls the speed of the supercritical CO2 prime mover cylinders along with cylinders that pump the refrigerant. PLC based control systems such as described above with respect to FIGS. 2-9 may be used to perform the various control functions described herein. Further, though described within the context of a PLC based control system, other controls systems may be used to provide the desired control functions, such as other specific purpose and/or general purpose computing systems programmed to achieve the desired functions.

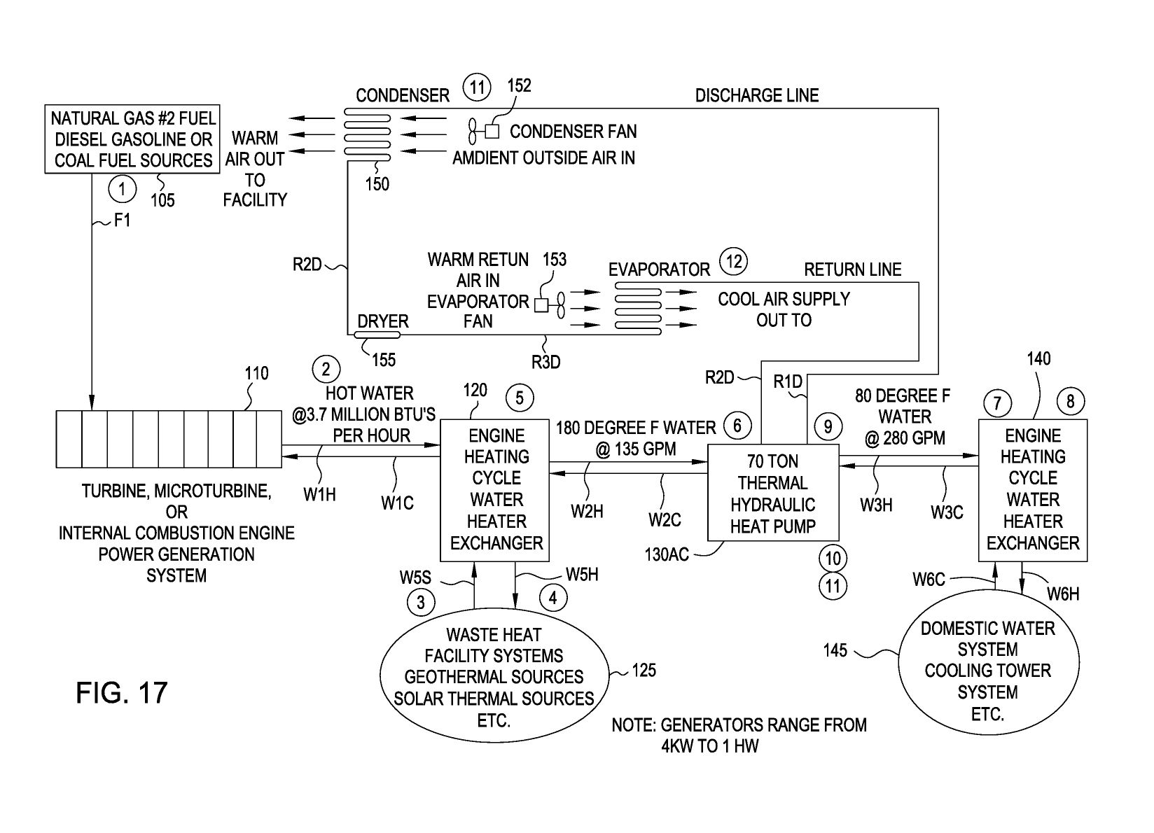

FIG. 17 depicts a high level block diagram of a system including various embodiments. Generally speaking, FIG. 17 depicts a flow and interconnection diagram for a system comprising a Thermal Hydraulic DC Generator connected to a microturbine system to capture waste heat from the exhaust and increase the efficiency of the overall system. Since portions of the system 1700 of FIG. 17 are similar to those described above with respect to the system 100 of FIG. 1, only those differences between the two systems will be discussed in detail.

Referring to FIG. 17, a system 100 includes a fuel source 105 (e.g., natural gas, #2 fuel, diesel, gasoline, coal or other fuel source), a power generation system 110 (illustratively a turbine, micro-turbine, internal combustion engine or other power generation system), an engine heating cycle water heat exchanger 120, optional heat sources 125 (illustratively waste heat from facility systems, heat from geothermal sources, heat from solar thermal sources etc.), a thermal hydraulic heat pump 130 (illustratively a 70 Ton, or other heat pump ranging from 1 Ton to 255 Ton), an engine cooling cycle water heat exchanger 140 and cooling sources 145 (illustratively a domestic water system, a cooling tower system and the like).

The engine heating cycle water heat exchanger 120 receives 180° F. water from the power generation system 110 via path W1H (illustratively at 3.7 million BTUs per hour), and returns cooler water to the power generation system 110 via path WIC. The engine heating cycle water heat exchanger 120 may receive hot water from optional heat sources 125 via path WSH, and return cooler water to the optional heat sources 125 via path WSC.

The engine heating cycle water heat exchanger 120 provides hot water to the thermal hydraulic DC generator 130 via path W2H, and receives cooler water from the thermal hydraulic DC generator 130 via path W2C. In the illustrated embodiment, path W2H supplies 180° F. water at a rate of 135 gallons per minute to a 70 Ton heat pump 130.

The thermal hydraulic heat pump 130 provides hot water to the engine cooling cycle water heat exchanger 140 via path W3H, and receives cooler water from the engine cooling cycle water heat exchanger 140 via path W3C. In the illustrated embodiment, path W3C supplies 80° F. water at a rate of 280 gallons per minute to a 70 Ton thermal hydraulic heat pump 130.

The engine cooling cycle water heat exchanger 140 provides hot water to cooling sources 145 via path W4H, and receives cooler water from the cooling sources 145 via path W4C. The thermal hydraulic heat pump 130 pumps transcritical CO2 refrigerant or, other types of refrigerant, in response to the temperature differential between the 180° F. water provided via the W2H/W2C fluid loop and the 80° F. water provided via the W3H/W3C fluid loop. In a continuous loop, the thermal hydraulic heat pump 130 pumps refrigerant to a condenser 150 via path R1D, a dryer 155 via path R2D, an evaporator 160 via path nine, and back to the thermal hydraulic heat pump via path R1R.

Ambient outside air can be blown, via a condenser fan 152, across the condenser 150 into the facility in various embodiments to meet the heating demand loads for the facility or warm return air can be blown, via a condenser fan 153, across the evaporator 160 to meet the cooling demand loads for the facility. In various embodiments the condenser fan 152 and evaporator fan 153 may comprise a single fan adapted for both functions via ducts and the like. An operating methodology associated with the system 1700 of FIG. 17 will now be described with respect to the below steps, each of which is indicated in FIG. 17 by a corresponding circled number.

Step 1. Natural Gas, Methane, #2 Fuel Oil, or Diesel Fuel can be used to power Turbine Generators or Combustion Engine Generators that produce electricity and create waste heat.

Step 2. The exhaust from the Turbine Generators or Combustion Engine Generators Heat circulated water through manifolds or engine water jackets.

Step 3. Additional energy may be recovered from the Turbine Generators or Combustion Engine Generators exhaust systems through the use of an air over water secondary 90 heat exchanger that is incorporated with the same hot water closed loop system as the manifolds or the water jackets.

Step 4. Additional energy may be recovered from other building systems through the use of a water/steam over water secondary heat exchanger, Geothermal Sources, or Solar Collectors that are incorporated with the same hot water closed loop system as the Turbine Generators or Combustion Engine manifolds or water jackets.

Step 5. The temperature of the hot water closed loop system is regulated at 180 degrees F. by the use of variable frequency drive (VFD) controlled circulating pumps. The temperature is a function of the water flow in the system. The flow of the water is regulated by the rpm of the circulating pumps. The VFDs are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic DC Generator Engine is at approximately 150 degrees F.

Step 6. The 180-degree F. water is circulated through a Thermal Hydraulic Heat Pump. The water is used to expand liquid carbon dioxide which in turn drives a piston in one direction. A solenoid valve that is controlled by the PLC based control system controls the water flow. The liquid carbon dioxide does not experience a phase change. The Thermal Hydraulic Heat Pump does not involve an intake and exhaust cycle. It is very efficient and has a very long life expectancy with minimal maintenance requirements.

Step 7. An 80-degree F. cooling-water closed loop system is also required to operate the Thermal Hydraulic Heat Pump. This cooling-water loop is circulated through a sanitary water over water heat exchanger that is installed in the domestic water system or through a water over water heat exchanger that is connected to a cooling tower or a cooling water piping system in the ground. The domestic water temperature is usually around 70-80 Degrees F. The cooling water that returns from the Thermal Hydraulic Heat Pump is at approximately 100 degrees F.

Step 8. The temperature of the cooling water closed loop system is regulated by the use of variable frequency drive controlled circulating pumps. The temperature is a function of the water flow in the system. The flow of the water is regulated by the rpm of the circulating pumps. The VFDs are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic Heat Pump is at approximately 170 degrees F.

Step 9. The 80-degree F. water is circulated through a Thermal Hydraulic Heat Pump. The water is used to contract supercritical carbon dioxide, which in turn drives a piston in the opposite direction from expanded supercritical carbon dioxide. A solenoid valve that is controlled by a PLC based control system controls the water flow.

Step 10. The Thermal Hydraulic Heat Pump drives a hydraulic pump. The pistons moving back and forth pump hydraulic fluid. The pistons/cylinders pump refrigerant. The flow of the refrigerant is regulated by PID loops in the PLC based control system. The PLC program coordinates the opening and closing of the solenoid valves for the heating and cooling water loops with the required flow rate of the transcritical CO2 refrigerant or other refrigerants.

Step 11. The transcritical CO2 refrigerant or other refrigerants is pumped through a condenser. Ambient air is blown across the condenser as the refrigerant is circulated. This process warms the ambient air. The air is used to meet the heating demand loads of the facility. The PLC based control system measures/calculates the heating demand loads, controls the speed of the supercritical CO2 prime mover cylinders of the thermal hydraulic heat pump, and controls the flow of refrigerant through the condenser.

Step 12. The transcritical CO2 refrigerant or other refrigerants is pumped through an evaporator 160. Warm return air is blown across the evaporator as the refrigerant is circulated. This process cools the ambient air. The air is used to meet the cooling demand loads of the facility. The PLC based control system measures/calculates the cooling demand loads, controls the speed of the supercritical CO2 prime mover cylinders of the thermal hydraulic heat pump, and controls the flow of refrigerant through the evaporator.

In various embodiments, the PLC based control system performs one or more of the following functions:

1. Regulate the temperatures, pressures and flow rates for the heating cycle and cooling cycle water system.

2. Regulate the temperatures, pressures and flow rates for the hydraulic systems.

3. Control the firing rate of the solenoid valves to regulate the engine speed.

4. Control the inverter output.

5. Control associated generation systems.

6. Monitor the electrical system load demand.

7. Communicate with multifunction relays associated with the utility service.

8. Data Collection System

9. Alarm system

In various embodiments, the PLC based control system utilizes one or more of the following devices:

1. Microprocessor or other computing device

2. Analog Input Module

3. Analog Output Module

4. Discrete Input Module

5. Discrete Output Module

6. RTD Temperature Sensors

7. Differential Pressure Transmitters

8. Flow Meters

9. Variable Frequency Drives

10. Multifunction Protective Relays

11. Current Sensors

12. Voltage sensors

13. Frequency Sensors

14. Operator Interface Terminal

15. Data Collection System

16. Alarm System

As previously noted, the control system also controls the speed of the supercritical CO2 prime mover cylinders along with cylinders that pump the refrigerant.

PLC based control systems such as described above with respect to FIGS. 2-9 may be used to perform the various control functions described herein, though different received signaling, output control signals and the like may be required as would be understood by one skilled in the art. Further, though described within the context of a PLC based control system, other controls systems may be used to provide the desired control functions, such as other specific purpose and/or general purpose computing systems programmed to achieve the desired functions.

Thermal Hydraulic Heat Pump Structure Vs. Thermal Hydraulic Generator Structure.

The various thermal hydraulic heat pump related embodiments discussed herein utilize a stable thermal hydraulic heat pump having a physical structure similar to the stable thermal hydraulic generator discussed above with respect to FIG. 15. That is, the thermal hydraulic generator structure discussed above with respect to FIG. 15 is modified herein to realize a thermal hydraulic heat pump structure for use in various embodiments.

It is noted that the thermal hydraulic generator discussed above with respect to FIG. 15 as well as the modification to such structure to realize the thermal hydraulic heat pump retains the use of supercritical CO2 liquid as a prime mover of a piston within a center cylinder, wherein the center cylinder piston is coupled via a continuous shaft to pistons in first and second axially aligned cylinders disposed upon either side of the center cylinder.

However, while the thermal hydraulic generator of FIG. 15 uses hydraulic fluid within the first and second axially aligned cylinders, the thermal hydraulic heat pump is realized using a refrigerant within the first and second axially aligned cylinders.

Generally speaking, the diameters, dimensions and piping sizes selected to realize a thermal hydraulic heat pump 18′ depend upon the specific application of that thermal hydraulic heat pump 18′. It is further noted that the supercritical CO2 has a very high coefficient of thermal expansion and is used as the prime mover for the thermal hydraulic heat pump. The operating parameters in various embodiments are selected at 1600 psi with a temperature range between 80 and 180° F. Relatively constant parameters of temperature and pressure are used to keep the CO2 in a supercritical state. The supercritical CO2 is heated/expanded and cooled/contracted via heat exchangers such as described below. The temperatures of the CO2 and hydraulic cylinders are regulated by circulating heat and cooling water through the outer casings of the cylinders. The same hot water and cooling water sources may be used to circulate through various heat exchangers. In various embodiments, the temperate outer casings of the cylinders also enable effective heat transfer to take place in order to expand and contract the supercritical CO2 in an efficient manner. The temperate outer casings of the cylinders also ensure proper sealing of the internal O-rings by limiting access of expansion and contraction of the cylinder casings. In various embodiments, maintaining trans-critical CO2 in the outer cylinders at 1070 psi and 80° F. enables the use of environmentally in the refrigerants such as ammonia and the like, the Freon may also be used.

The thermal hydraulic heat pump realized in the above manner advantageously provides a process in which hot water expands the supercritical CO2 while cool water contracts supercritical CO2. This process operates by molecular expansion and contraction such that there are very few moving parts and, therefore, a very long life expectancy for the system. In various embodiments there are no intake and exhaust cycles to lower the operating efficiency. Further, there is no wasted motion to lower operating efficiency. Trans-critical CO2 refrigerant is pumped with both directions of motion by the cylinders.

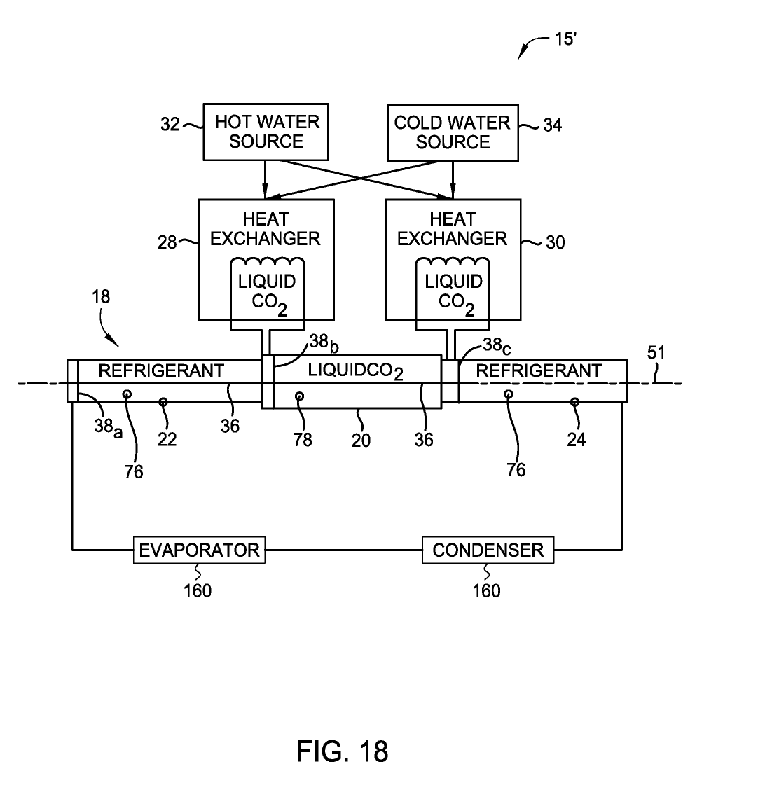

Further modifications may include differences in operational control and the like as well be described within the context of the various embodiments utilizing a thermal hydraulic heat pump, such as now described with respect to FIG. 18.

FIG. 18 is a block diagram of a system comprising a full cycle thermal hydraulic heat pump system according to an embodiment. Specifically, FIG. 18 depicts a full cycle thermal hydraulic heat pump system 15′ having a topology similar in some respects to the topology of the full cycle thermal hydraulic generator system 15 of FIG. 14. However, there are several very important differences.

First, the system 15′ of FIG. 18 utilizes a thermal hydraulic heat pump 18′ rather than the thermal hydraulic generator 18 used in the system 15 of FIG. 14. Other differences will become apparent in the below question.

The thermal hydraulic heat pump 18′ is realized by modifying the structure of FIG. 15, so the description provided below in reference to the generator 18′ refers to both FIGS. 18 and (as modified) 15. According to one embodiment, the thermal hydraulic heat pump (or assembly) 18′ comprises an assembly of three chambers 20, 22 and 24 each having a cylindrical elongated shape. The chamber 20 is built around an axis and comprises an internal cavity 78, located inside of the chamber 20 and having an outer wall (casing 72) through a length of the chamber 18′, including at least two inlets (62a and 62b) for entering a liquid such as supercritical CO2 into the internal cavity. The liquid (e.g., CO2) may be maintained in the internal cavity 78 in a liquid state using predefined combinations of pressures and temperature, where a temperature of the liquid (or its portions) can be alternated between preselected two temperatures (e.g., approximately 80F and 180F for CO2 implementation) during operation of said thermal hydraulic heat pump 18′. When the supercritical CO2 is heated to 180F, it expands, whereas when the supercritical CO2 is cooled to 80F, it contracts.

According to a further embodiment, the internal cavity 78 may further comprise at least two outlets 64a and 64b, so that the liquid entered through the first or second inlet 62a or 62b can circulate through a corresponding first or second outlet 64a or 64b for faster temperature stabilization of the corresponding liquid portions, wherein one liquid circulating pair comprises the first inlet 62a and the first outlet 64a located near one end of the internal cavity 78 and another liquid circulating pair comprises the second inlet 62b and the second outlet 64b located near an opposite end of the internal cavity 78. The two chambers 22 and 24 are refrigerant chambers, each built around a further axis, and having a further internal cavity 76, located inside of the refrigerant chamber 22 or 24 and having an outer wall (casing 52) through a length of the refrigerant chamber 22 or 24, including at least two inlets/outlets 58 and 60 for moving refrigerant in and out of the further internal cavity 76.

Moreover, these three chambers 20, 22 and 24 are rigidly attached to each other at respective ends with the chamber 20 being in between the two refrigerant chambers 22 and 24 (e.g., a first end of the chamber 20 is attached to one end of a first refrigerant chamber 22 and a second end of the chamber is attached to one end of a second refrigerant chamber 24, such that the axis of the chamber 20 and further axes of the two refrigerant chambers 22 and 24 forming a common axis 51 with a continuous moving shaft 36 inserted in this assembly 18′ of the chambers 20, 22 and 24. The shaft 36 has three pistons 38 shaped as round thin plates and rigidly connected to the shaft 36 in predefined positions with surfaces of the three round plates being perpendicular to the common axis 51. It is seen from FIGS. 18 and (as modified) 15 that two pistons 38a and 38c are positioned at respective ends of the shaft 36, so that when the shaft 36 is in a middle position in the assembly 18′, each of the two pistons 38a and 38c is located approximately in the middle of the corresponding first and second refrigerant chambers 22 and 24 and a third piston 38b is located approximately in the middle of the chamber 20. Each piston 38a, 38b or 38c separates into two portions a corresponding liquid or fluid in each of the corresponding chambers 20, 22 and 24 of the assembly 18′.

Furthermore, each piston 38a, 38b or 38c comprises an O-ring on its outside perimeter and is in contact with corresponding outer walls (casings) 52 and 72 in the corresponding internal cavities 78 and 76 providing, when the shaft 36 moves, a smooth sliding of the corresponding pistons 38a, 38b and 38c with O-rings 70 along the outer walls 52 and 72 of corresponding internal cavities 78 and 76 in these three chambers 20, 22 and 24.

According to an embodiment, a principle of operation of the thermal hydraulic heat pump 18′ is described as follows. As stated above in reference to FIG. 15, the internal cavity 78 of the chamber 20 comprises two inlets 62a and 62b located at opposite ends of the internal cavity 78. Then during a first half of a time cycle, one of the two inlets (e.g., 62a) can be used to enter the liquid having a high temperature expansion coefficient at a low preselected temperature (such as 80F for the supercritical CO2) and another inlet (e.g., inlet 62b) can be used to enter the same liquid at a high preselected temperature (such as 180F for the supercritical CO2), so that the piston 38b separating liquids having low and high preselected temperatures is moved in a direction of the internal cavity portion comprising the liquid at the low preselected temperature (piston 38b moves toward the inlet 62a) due to a higher expansion coefficient of the supercritical (CO2) having the high preselected temperature. The shaft 36 (rigidly connected to the pistons) moves in the same direction as the piston 38b further causing the pistons 38a and 38c to be moved in the same direction due to rigidity of the shaft construction and to move the refrigerant located in the refrigerant chambers 22 and 24.

Moreover, during a second half of a time cycle, temperatures of the liquid provided to the two inlets 62a and 62b are reversed, so that the piston 38b separating liquids having the low and high preselected temperatures is moved in an opposite direction (piston 38b moves toward the inlet 62b), thus simultaneously moving in the same opposite direction the pistons 38a and 38b and the refrigerant located in the refrigerant chambers 22 and 24. The full time cycle for the heat pump 18′ may be approximately 10 seconds. It can be improved by using circulation of the supercritical (CO2) provided to the inlets 62a and 62b through the corresponding outlets 64a and 64b for faster temperature stabilization at a desired temperature of the corresponding liquid portions, as described above.

The refrigerant that is pumped to the evaporator and condenser 26 (shown in FIG. 18) in the 1st and 2nd time cycles described herein, may provide refrigerant during both time cycles, thus maximizing efficiency of the thermal hydraulic heat pump 18′ compared to a conventional half cycle thermal hydraulic heat pump. In the examples shown in FIGS. 18 and (as modified) 15, one possible liquid with a high temperature expansion coefficient to use in the internal cavity 78 of the chamber 20, among other possible candidates, may be the supercritical CO2 with two alternating temperatures (e.g., approximately 80F and 180F). According to a further embodiment, additional outer chamber(s) 53a and 53b around the internal cavity 78 in the chamber 20 may be used for circulating a fluid (e.g., a water) to maintain the liquid in the internal cavity 78 in a liquid state and to accelerate cooling of the liquid from the high preselected temperature (e.g., 180F for CO2) to the low preselected value (e.g., 80F for the supercritical CO2) during operation of the system 15.

Moreover, each outer chamber 53a and 53b may have its own inlets/outlet 66 and 68 respectively. In alternative implementation chambers 53a and 53b may be combined into one outer chamber. The temperature of the circulating fluid (such as water) in the chambers 53a and 53b may be in a range between 80F and 100 F to maintain the liquid such as CO2 in the internal cavity 78 in the supercritical state and to accelerate cooling of that liquid to the low temperature 80F during operation. Similarly, outer chambers 55 for circulating the fluid (such as water) through inlet/outlet 58 and 60 may be used in the refrigerant chambers 22 and 24 for stabilizing their operation.

As stated above, the liquid is provided to each of the two inlets 62a and 62b by one of the two heat exchangers 28 and 30 shown in FIG. 18, where each of the heat exchangers 28 and 30 alternates a liquid temperature between the low (e.g., 80F) and high (e.g., 180F) preselected temperatures. Sources of hot (e.g., 180F) and cold (e.g., 80F) water 32 and 34 respectively, can provide alternatively (switches are not shown in FIG. 18) in each half time cycle the water at different temperatures to the corresponding heat exchanges 28 and 30 to heat or to cool the liquid (e.g., CO2) provided to the corresponding inlets 62a and 62b of the chamber 22, as explained herein. Heat exchangers 28 and 30 are operated in anti-phase in time domain. In other words, during the half time cycle when one of the heat exchanges 28 and 30 heats the liquid to the high preselected temperature, the other heat exchanger cools the liquid to the low preselected temperature.

In another embodiment the outer chambers 53a, 53b, 50 of each of the three chambers 20, 22 and 24 and their respective inlets and outlets may be rated at 100 PSI, and the internal cavity 78 and all inlets and outlets (62a, 62b, 64a and 64b) associated with the internal cavity may be rated at 2000 PSI.

The heat exchanger 28 and 30 may be implemented in, for example, the manner described above with respect to the heat exchanger or chamber 80 of FIG. 16. Generally speaking, the diameters, dimensions and piping sizes selected to realize the heat exchangers 28 and 30, condenser 150, evaporator 160 and the like depend upon their respective specific applications, and such applications give rise to the considerations discussed above with respect to that of the thermal hydraulic heat pump 18′.

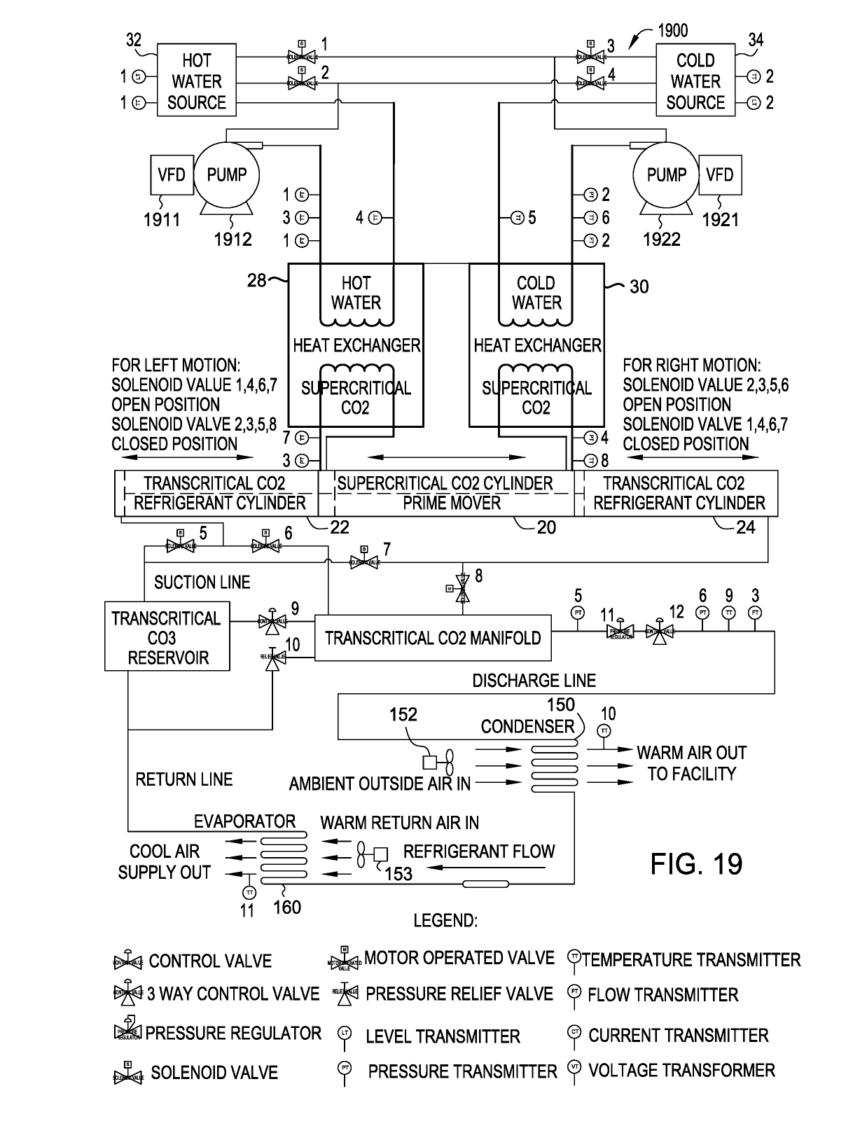

FIG. 19 depicts a schematic diagram of thermal hydraulic heat pump piping and instrumentation according to an embodiment. Specifically, FIG. 19 depicts a schematic diagram showing interconnections between various components such as noted above with respect to the other figures. As such, the same or similar elements will be designated by the same reference numerals used in prior figures. Additional elements depicted in FIG. 19 include various control elements such as control valves, pressure regulators, solenoid valves, motor operated valves, pressure relief valves, level transmitters, pressure transmitters, temperature transmitters, flow transmitters, current transformers, voltage transformers and the like as indicated in the legend of FIG. 19. Each of the various elements is numerically labeled and graphically indicated such that there operation may be readily understood.

Referring to FIG. 19, a pump 1912 controlled by a VFD 1911 pumps hot water from a hot water source 32 to a heat exchanger 28. Similarly, a pump 1922 controlled by a VFD 1921 pumps cold water from a cold water source 34 to a heat exchanger 30. Control of these pumps is performed in accordance with the operation of relevant elements as described above with respect to the various figures.

FIG. 19 also depicts a trans critical CO2 reservoir 1930 operatively coupled to transcritical CO2 refrigerant cylinder 22, trans critical CO2 refrigerant cylinder 24, trans critical CO2 manifold 1940, and evaporator 160.

Various elements of FIG. 19 operate in accordance with the following control sequence:

1. The heating and cooling load demands are measured by a temperature transducer (TT) 10 positioned to measure the temperature of a warm air output of the condenser 150, and a TT 11 positioned to measure the temperature of a cool air supply output of the evaporator 160. These temperatures are indicative of heating and cooling load demands for a facility with HVAC supply/management provided as described herein.

2. The sequencing rates of various solenoid valves 1 through 8 are calculated based on the heating and cooling Load demands for the facility. It is noted that solenoid valves 1-4 enable water flow between hot water source 32 and cold water source 34, solenoid valve 5 enables trans critical CO2 flow between reservoir 1930 and left cylinder 22, solenoid valve 6 enables trans critical CO2 flow between left cylinder 22 and trans critical CO2 manifold 1940, solenoid valve 7 enables trans critical CO2 flow between reservoir 1930 and right cylinder 24, and solenoid valve 8 enables trans critical CO2 flow between right cylinder 24 and trans critical CO2 manifold 1940.

3. The flow rates of the hot and cold water loops are calculated to maintain respective 180° F. and 80° F. temperatures by adapting the operation of, respectively, VFD 1911 and VFD 1921. This adaptation is performed in response to flow transmitter (FT) 1 proximate pump 1912 and FT 2 proximate pump 1922, as well as various temperature indicators (TI) 3-6.

4. The flow rate of the refrigerant to the coils of the Condenser 150 and evaporator 160 coils is calculated based on the heating and cooling load demands for the Facility being managed in accordance with pressure transmitter (PT) 5 and PT 6, as well as TI 9 and FT 3. The flow rate is controlled via a control valve 12 between manifold 1940 and condenser 150. An optional pressure regulator 11 maybe set for the operating pressure of the refrigerant; an optional relief valve 10 may be provided for pressure safety.

6. The refrigerant flow, temperature, and pressure are measured using TI 9, PT 6 and FT 3.

7. The sequencing rate of solenoid valves 1 through 8 are recalculated based on changes in thermal load/demand. These calculations maybe continually updated with the use of a PID loop in the PLC or other control program.

The pressures and temperatures of the supercritical CO2 our used as the prime mover in the cylinder, and the Heat exchangers 28 and 30 measured by PT 3, PT 4, TT 7 and TT 8. When operative, the CO2 is always kept in the supercritical state so that there is no phase change of the CO2. It is noted that supercritical CO2 has a very high coefficient of thermal expansion and negligible compressibility. This enables the thermal hydraulic heat pump to operate with a high torque rating with speeds between 2-6 stokes per minute in the primary embodiments described herein.

In the various embodiments, supercritical CO2 is maintained at 1600 psi between 80 and 180° F. and is used as the prime mover for the central cylinder 20 of the thermal hydraulic heat pump. Similarly, in various embodiments trans critical CO2 is maintained at 1070 psi and 80° F. In other embodiments lower or higher pressures and/or temperatures may be used for one or both of the supercritical CO2 and trans critical CO2 depending upon design choices such as pump size/capacity and the like.

The various embodiments generally depict a thermal hydraulic heat pump cylinder design wearing center cylinder including supercritical CO2 is utilized as the prime mover, while left end and right and cylinders using trans critical CO2. Supercritical CO2 is expanded and contracted to move the piston in two different linear directions. The end cylinders use transcritical CO2 as a refrigerant. All three cylinders have one common shaft for the pistons. There is no wasted motion. The center chamber maybe rated for 2000 psi and is used to expand and contract supercritical CO2. The next chamber may be rated for 100 psi and used to circulate 180 degree F. or 80 degree F. water in order to expand or contract the supercritical CO2 in the center chamber. The outer chamber maybe rated for 100 psi and is used to circulate water at 100 degree F. to temper the equipment and make a fully stable system.

A system according to one embodiment comprises a thermal hydraulic heat pump, for meeting heating and cooling load demands for facilities in response to a control signal; and a controller, for adapting the control signal in response to an HVAC system load demand associated with the heating and cooling loads, the control signal being adapted to cause the thermal hydraulic heat pump to adapt the output power such that the heat pump satisfies the HVAC system load demands.

In an embodiment of the above system, the thermal hydraulic heat pump May comprise a heat pump driven by a refrigerant pump, the refrigerant pump driven by an engine, the engine driven by alternately circulating therein hot water and cool water, wherein a rate of alternately circulating the hot water and cool water therein is adapted in response to the control signal. In one embodiment, the hot water has a temperature of approximately 180° F. water, and the cool water has a temperature of approximately 80° F. water.

In an embodiment of the above system, the rate of alternately circulating the hot water and cool water is reduced in response to a control signal of low HVAC system load demand; and the rate of alternately circulating hot water and cool water is increased in response to a control signal indicative of high HVAC system load demand.

In an embodiment of the above system, the thermal hydraulic heat pump comprises a heat pump driven by a refrigerant pump, the refrigerant pump driven by an engine, the engine driven by alternately circulating therein hot water and cool water, wherein a flow rate of one or both of the hot water and cool water circulating therein is adapted in response to the control signal.

In an embodiment of the above system, the system further comprises an engine heating cycle water heat exchanger for generating the hot water at a flow rate determined by a variable frequency drive (VFD) controlled circulating pump responsive to the control signal. In one embodiment, the engine heating cycle water heat exchanger thermally communicates with a power generation system to receive heat therefrom. In one embodiment, the engine heating cycle water heat exchanger receives heated water via thermal communication with one or more of a power generation system, a combustion engine, a geothermal source, and a solar collector.

In an embodiment of the above system, the system further comprises an engine cooling cycle water heat exchanger for generating the cool water at a flow rate determined by a variable frequency drive (VFD) controlled circulating pump responsive to the control signal. In one embodiment, the engine cooling cycle water heat exchanger thermally communicates with one or more cooling sources to deliver heat thereto.

An apparatus according to one embodiment comprises a chamber, having a cylindrical elongated shape and built around an axis, comprising: an internal cavity, located inside of the chamber, having an outer wall through a length of the chamber, including at least one inlet for entering a liquid into the internal cavity, the liquid is maintained in the internal cavity in a liquid state using predefined combinations of pressures and temperatures, where a temperature of the liquid is alternated between preselected two values during operation of the apparatus; and one or more outer chambers located around the internal cavity through the length of the internal cavity for circulating a fluid at least in one of the one or more outer chambers to maintain the liquid in the internal cavity in the liquid state and to accelerate cooling of the liquid during operation of the apparatus, wherein each outer chamber of the one or more outer chambers has at least one inlet and at least one outlet for circulating the fluid and is surrounded by inner and outer walls having elongated cylindrical shapes such that the inner wall of a first outer chamber of the one or more outer chambers is shared with the outer wall of the internal cavity.

In an embodiment of the apparatus, the fluid is water, and the liquid is CO2 and the two preselected values are approximately 80F and 180F.

In an embodiment of the apparatus, the chamber is a heat exchanger comprising two outer chambers of the one or more outer chambers, wherein the inner wall of a second chamber of the one or more chambers is shared with the outer wall of the first chamber, wherein the internal cavity comprises at least one outlet for the liquid to be provided outside of the heat exchanger. In another embodiment, the liquid is CO2 and the first outer chamber provides a circulating fluid at alternating temperatures of approximately 80F and 180F and the second outer chamber provides a further circulating fluid at a range of temperatures between 80F and 100 F to maintain the liquid in the internal cavity in the liquid state and to accelerate cooling of the liquid to the temperature of 80F during operation of the apparatus.

In an embodiment of the apparatus, each of the one or more chambers and corresponding inlets and outlets associated with one or more chambers are rated at 100 PSI, and the internal cavity and all inlets and outlets associated with the internal cavity are rated at 2000 PSI.

In an embodiment of the apparatus, the liquid as a predefined high temperature expansion coefficient.

In an embodiment of the apparatus, the internal cavity of the chamber comprises at least one outlet.

In an embodiment of the apparatus, the apparatus comprises a thermal hydraulic heat pump comprising an assembly of three chambers including the chamber, having the cylindrical elongated shape and built around the axis, and two refrigerant chambers, each having a further cylindrical elongated shape and built around a further axis, the three chambers are rigidly attached to each other at respective ends with the chamber being in between the two refrigerant chambers, such that the axis of the chamber and further axes of the two refrigerant chambers forming a common axis with a continuous moving shaft inserted in the assembly, the shaft having three pistons shaped as three round plates and rigidly connected to the shaft in predefined positions with surfaces of the three round plates being perpendicular to the common axis, two of the three pistons being positioned at respective ends of the shaft, so that when the shaft being in a middle position in the assembly, each of the two pistons is located approximately in the middle of the corresponding first and second hydraulic fluid chambers and a third piston being located approximately in the middle of the chamber, where each piston of the three pistons separates a corresponding liquid or fluid in each of the three chambers of the assembly into two portions.

In an embodiment of the apparatus, each of the two hydraulic fluid chambers having a further internal cavity, located inside of the refrigerant chamber, having a further outer wall through a length of the refrigerant chamber, including at least two inlets/outlets for moving a refrigerant in and out of the further internal cavity, and a further outer chamber located around the further internal cavity through the length of the further internal cavity for circulating a fluid for stabilizing a refrigerant temperature inside of the further internal cavity.

In an embodiment of the apparatus, each piston comprises an O-ring on an outside perimeter of the piston, the O-ring being in contact with a corresponding outer walls in the corresponding internal cavity in each of the three chambers providing, when the shaft moves, a smooth sliding of the corresponding pistons with O-rings along the outer walls of the corresponding internal cavities in the three chambers.

In an embodiment of the apparatus, the internal cavity of the chamber comprises two inlets located at opposite ends of the internal cavity, where, during a first half of a time cycle, one of the two inlets in the internal cavity of the chamber is used to enter the liquid at a low preselected temperature, and another inlet of the two inlets is used to enter the liquid at a high preselected temperature, such that the piston separating portions of the liquid having respective low and high preselected temperatures is moved in a direction of the internal cavity portion comprising the liquid at the low preselected temperature due to a higher expansion coefficient of the liquid having the high preselected temperature, thus simultaneously moving in the same direction the pistons and the refrigerant located in the refrigerant chamber, where, during a second half of a cycle, temperatures of the liquid provided to the two inlets are reversed, so that the piston separating liquids having the low and high preselected temperatures is moved in an opposite direction, thus simultaneously moving in the opposite direction the pistons and the refrigerant located in the refrigerant chamber, thus providing refrigerant to thee evaporator and the condenser during both the first and second cycles.

In an embodiment of the apparatus, the internal cavity further comprise two outlets located at opposite ends of the internal cavity, so that the liquid provided to each of the two inlets is circulated through the corresponding outlet of the two outlets to speed up temperature stabilization of the liquid to a desired temperature on both ends of the internal cavity.

In an embodiment of the apparatus, the liquid is provided to each of the two inlets by one of two heat exchangers, where each of the heat exchangers alternates a liquid temperature between the low and high preselected temperatures.

A thermal hydraulic heat pump according to one embodiment comprises: an assembly of three chambers each having a cylindrical elongated shape, the three chambers including: a chamber built around an axis comprising an internal cavity, located inside of the chamber and having an outer wall through a length of the chamber, including at least two inlets for entering two portions of a liquid into the internal cavity, the liquid is maintained in the internal cavity in a liquid state using predefined combinations of pressures and temperatures, where a temperature in each portion of the liquid is alternated between two preselected temperatures during operation of the thermal hydraulic heat pump; and two refrigerant chambers, each built around a further axis, and having a further internal cavity, located inside of the hydraulic fluid chamber and having a further outer wall through a length of the refrigerant chamber, including at least two inlets/outlets for moving a refrigerant in and out of the further internal cavity, the three chambers are rigidly attached to each other at respective ends with the chamber being in between the two refrigerant chambers, such that the axis of the chamber and further axes of the two refrigerant chambers forming a common axis with a continuous moving shaft inserted in the assembly, the shaft having three pistons shaped as three round plates and rigidly connected to the shaft in predefined positions with surfaces of the three round plates being perpendicular to the common axis, two of the three pistons being positioned at respective ends of the shaft, so that when the shaft being in a middle position in the assembly, each of the two pistons is located approximately in the middle of the corresponding first and second hydraulic fluid chambers and a third piston being located approximately in the middle of the chamber, where each piston of the three pistons separates into two portions a corresponding liquid or fluid in each of the three chambers of the assembly.

In an embodiment of the thermal hydraulic heat pump, each piston comprises O-ring on an outside perimeter of the piston, the O-ring being in contact with corresponding outer walls in the corresponding internal cavities of the three chambers providing, when the shaft moves, a smooth sliding of the corresponding pistons with O-rings along corresponding outer walls of the corresponding internal cavities in the three chambers.

In an embodiment of the thermal hydraulic heat pump, the internal cavity of the chamber comprises two inlets located at opposite ends of the internal cavity, where, during a first half of a time cycle, a first inlet of the two inlets is used to enter the liquid at a low preselected temperature and a second inlet of the two inlets is used to enter the liquid at a high preselected temperature, such that the piston separating liquids having the low and high preselected temperatures is moved in a direction of the internal cavity portion comprising the liquid at the low preselected temperature due to a higher expansion coefficient of the liquid having the high preselected temperature, thus simultaneously moving in the same direction the pistons and the refrigerant located in the hydraulic fluid chamber, where, during a second half of a time cycle, temperatures of the liquid provided to the two inlets are reversed, so that the piston separating liquids having the low and high preselected temperatures is moved in an opposite direction, thus simultaneously moving in the same opposite direction the pistons and the refrigerant located in the refrigerant chambers, thus providing refrigerant to the evaporator and condenser to meet the heating and cooling load demands for the facility during both the first and second cycles, wherein the liquid is provided to each of the two inlets by one of two heat exchangers, where each of the heat exchangers alternates a liquid temperature between the low and high preselected temperatures.

In an embodiment of the thermal hydraulic heat pump, a first end of the chamber is attached to one end of a first of the refrigerant chambers and a second end of the chamber is attached to one end of a second of the refrigerant chambers.

In an embodiment of the thermal hydraulic heat pump, the internal cavity further comprises at least two outlets, so that the liquid entered through the first or second outlet of the at least two input inlets circulates through a corresponding first or second outlet of the at least two outlets, wherein one liquid circulating pair comprising the first inlet and the first outlet of the internal cavity located near one end of the internal cavity and another liquid circulating pair comprising the second inlet and the second outlet of the internal cavity located near an opposite end of the internal cavity.

In an embodiment of the thermal hydraulic heat pump, moving refrigerant in the refrigerant chambers to the evaporator and condenser during both the first and second cycles in order to meet the heat heating and cooling demand loads for the facility.

In an embodiment of the thermal hydraulic heat pump, each of the three chambers has one outer chamber to circulate a fluid at a predefined temperature or a temperature range for stabilizing operation of the thermal hydraulic heat pump.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is to be understood that the foregoing description is intended to illustrate and not to limit the scope of the invention, which is defined by the scope of the appended claims. Other embodiments are within the scope of the following claims.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

What is claimed is:

1. A system, comprising:
a thermal hydraulic heat pump, for meeting heating and cooling load demands for facilities in response to a control signal;
a controller, for adapting said control signal in response to an HVAC system load demand associated with said heating and cooling loads, said control signal being adapted to cause said thermal hydraulic heat pump to adapt said output power such that said heat pump satisfies said HVAC system load demands.

2. The system of claim 1, wherein the thermal hydraulic heat pump comprises a heat pump driven by a refrigerant pump, the refrigerant pump driven by an engine, the engine driven by alternately circulating therein hot water and cool water, wherein a rate of alternately circulating said hot water and cool water therein is adapted in response to said control signal.

3. The system of claim 2, wherein:
said rate of alternately circulating said hot water and cool water is reduced in response to a control signal of low HVAC system load demand; and
said rate of alternately circulating hot water and cool water is increased in response to a control signal indicative of high HVAC system load demand.

4. The system of claim 2, wherein said hot water has a temperature of approximately 180° F. water, and said cool water has a temperature of approximately 80° F. water.

5. The system of claim 1, wherein the thermal hydraulic heat pump comprises a heat pump driven by a refrigerant pump, the refrigerant pump driven by an engine, the engine driven by alternately circulating therein hot water and cool water, wherein a flow rate of one or both of said hot water and cool water circulating therein is adapted in response to said control signal.

6. The system of claim 1, further comprising an engine heating cycle water heat exchanger for generating said hot water at a flow rate determined by a variable frequency drive (VFD) controlled circulating pump responsive to said control signal.

7. The system of claim 7, further comprising an engine cooling cycle water heat exchanger for generating said cool water at a flow rate determined by a variable frequency drive (VFD) controlled circulating pump responsive to said control signal.

8. The system of claim 6, wherein said engine heating cycle water heat exchanger thermally communicates with a power generation system to receive heat therefrom.

9. The system of claim 7, wherein said engine cooling cycle water heat exchanger thermally communicates with one or more cooling sources to deliver heat thereto.

10. The system of claim 6, wherein said engine heating cycle water heat exchanger receives heated water via thermal communication with one or more of a power generation system, a combustion engine, a geothermal source, and a solar collector.

11. An apparatus, comprising:
a chamber, having a cylindrical elongated shape and built around an axis, comprising: an internal cavity, located inside of the chamber, having an outer wall through a length of the chamber, including at least one inlet for entering a liquid into the internal cavity, said liquid is maintained in the internal cavity in a liquid state using predefined combinations of pressures and temperatures, where a temperature of said liquid is alternated between preselected two values during operation of said apparatus; and
one or more outer chambers located around the internal cavity through the length of the internal cavity for circulating a fluid at least in one of the one or more outer chambers to maintain the liquid in the internal cavity in the liquid state and to accelerate cooling of the liquid during operation of said apparatus, wherein each outer chamber of the one or more outer chambers has at least one inlet and at least one outlet for circulating the fluid and is surrounded by inner and outer walls having elongated cylindrical shapes such that the inner wall of a first outer chamber of the one or more outer chambers is shared with the outer wall of the internal cavity.

12. The apparatus of claim 11, wherein the chamber is a heat exchanger comprising two outer chambers of the one or more outer chambers, wherein the inner wall of a second chamber of said one or more chambers is shared with the outer wall of the first chamber, wherein the internal cavity comprises at least one outlet for said liquid to be provided outside of the heat exchanger.

13. The apparatus of claim 12, wherein said liquid is CO2 and the first outer chamber provides a circulating fluid at alternating temperatures of approximately 80F and 180F and the second outer chamber provides a further circulating fluid at a range of temperatures between 80F and 100 F to maintain the liquid in the internal cavity in the liquid state and to accelerate cooling of the liquid to said temperature of 80F during operation of said apparatus.

14. The apparatus of claim 11, wherein each of the one or more chambers and corresponding inlets and outlets associated with one or more chambers are rated at 100 PSI, and the internal cavity and all inlets and outlets associated with the internal cavity are rated at 2000 PSI.

15. The apparatus of claim 11, wherein said liquid having a predefined high temperature expansion coefficient.

16. A thermal hydraulic heat pump comprising:
an assembly of three chambers each having a cylindrical elongated shape, the three chambers including:
a chamber built around an axis comprising an internal cavity, located inside of the chamber and having an outer wall through a length of the chamber, including at least two inlets for entering two portions of a liquid into the internal cavity, said liquid is maintained in the internal cavity in a liquid state using predefined combinations of pressures and temperatures, where a temperature in each portion of said liquid is alternated between two preselected temperatures during operation of said thermal hydraulic heat pump; and
two refrigerant chambers, each built around a further axis, and having a further internal cavity, located inside of the hydraulic fluid chamber and having a further outer wall through a length of the refrigerant chamber, including at least two inlets/outlets for moving a refrigerant in and out of the further internal cavity, said three chambers are rigidly attached to each other at respective ends with said chamber being in between said two refrigerant chambers, such that said axis of the chamber and further axes of the two refrigerant chambers forming a common axis with a continuous moving shaft inserted in said assembly, the shaft having three pistons shaped as three round plates and rigidly connected to the shaft in predefined positions with surfaces of the three round plates being perpendicular to the common axis, two of the three pistons being positioned at respective ends of the shaft, so that when the shaft being in a middle position in said assembly, each of the two pistons is located approximately in the middle of the corresponding first and second hydraulic fluid chambers and a third piston being located approximately in the middle of said chamber, where each piston of the three pistons separates into two portions a corresponding liquid or fluid in each of the three chambers of the assembly.

17. The thermal hydraulic generator of claim 16, wherein each piston comprises O-ring on an outside perimeter of the piston, the O-ring being in contact with corresponding outer walls in the corresponding internal cavities of said three chambers providing, when the shaft moves, a smooth sliding of the corresponding pistons with O-rings along corresponding outer walls of the corresponding internal cavities in said three chambers.

18. The thermal hydraulic generator of claim 16, wherein said internal cavity of the chamber comprises two inlets located at opposite ends of the internal cavity, where, during a first half of a time cycle, a first inlet of the two inlets is used to enter the liquid at a low preselected temperature and a second inlet of the two inlets is used to enter the liquid at a high preselected temperature, such that the piston separating liquids having said low and high preselected temperatures is moved in a direction of the internal cavity portion comprising the liquid at the low preselected temperature due to a higher expansion coefficient of the liquid having the high preselected temperature, thus simultaneously moving in the same direction the pistons and the refrigerant located in the hydraulic fluid chamber, where, during a second half of a time cycle, temperatures of said liquid provided to the two inlets are reversed, so that the piston separating liquids having the low and high preselected temperatures is moved in an opposite direction, thus simultaneously moving in the same opposite direction the pistons and the refrigerant located in the refrigerant chambers, thus providing refrigerant to the evaporator and condenser to meet the heating and cooling load demands for the facility during both the first and second cycles, wherein the liquid is provided to each of the two inlets by one of two heat exchangers, where each of the heat exchangers alternates a liquid temperature between the low and high preselected temperatures.

19. The thermal hydraulic heat pump of claim 16, wherein moving refrigerant in said refrigerant chambers to the evaporator and condenser during both the first and second cycles in order to meet the heat heating and cooling demand loads for the facility.

20. The thermal hydraulic heat pump of claim 16, wherein each of the chambers has one outer chamber to circulate a fluid at a predefined temperature or a temperature range for stabilizing operation of the thermal hydraulic heat pump.
